(19) United States
(12) Patent Application Publication
(10) Pub. No.: US 2008/0312119 A1
(43) Pub. Date: Dec. 18, 2008

(54) Hard surface cleaning compositions comprising certain perfluroalkyl substituted compounds

(76) Inventors: Bingham S. Jaynes, New City, NY (US); John Jennings, Co. Galway (IE)

Correspondence Address: JoAnn Villamizar;Ciba Corporation/Patent Department, 540 White Plains Road, P.O. Box 2005, Tarrytown, NY, 10591, US

(21) Appl. No.: 12/157,635

(22) Filed: Jun. 12, 2008

Related U.S. Application Data
(60) Provisional application No. 60/934,556, filed on Jun. 14, 2007.

(51) Int. Cl. C11D 1/40

(52) U.S. Cl. 510/240; 510/407; 510/437

(57) ABSTRACT

This invention relates to hard surface cleaning compositions comprising certain perfluoroalkyl-substituted compounds. More particularly, it relates to novel compositions comprising perfluoroalkyl-substituted compounds which are the reaction products of a mono-, di- or polyamine of 60 to 10,000 molecular weight with a perfluoroalkyl-substituted unsaturated acid or its corresponding lower alkyl ester and optionally a non-fluorinated amino-reactive compound such as an acid, ester, anhydride, substituted epoxide, epichlorohydrin, isocyanate or urea. These compounds are useful as components of hard surface cleaning compositions.

This application claims benefit of U.S. provisional application No. 60/934,556, filed Jun. 14, 2007, the contents of which are hereby incorporated by reference.

### FIELD OF INVENTION

This invention relates to hard surface cleaning compositions comprising certain perfluoroalkyl-substituted compounds. More particularly, it relates to novel compositions comprising perfluoroalkyl-substituted compounds which are the reaction products of a mono-, di- or polyamine of 60 to 10,000 molecular weight with a perfluoroalkyl-substituted unsaturated acid or its corresponding lower alkyl ester and optionally a non-fluorinated amino-reactive compound such as an acid, ester, anhydride, substituted epoxide, epichlorohydrin, isocyanate or urea. These compounds are useful as components of hard surface cleaning compositions. The hard surface cleaning compositions or formulations can be used on many different surface types, such as ceramic tile, stone, glass, cement, concrete, plastic, polyurethane, bricks, plaster (for example, walls), marble and masonry; countertops of stone, marble or plastic; and wood, laminates or other types of floors made of organic or inorganic materials.

### BACKGROUND OF THE INVENTION

There is a strong consumer need for cleaning products that are effective at removing difficult soils and stains from hard surfaces in the home. These soils and stains may include soap scum, hard water stains, rust, greasy soils, mud, kitchen soils and toilet stains, among many others.

One approach is the use of perfluoroalkyl-substituted polymers to impart oil and water repellency to a variety of substrates, textiles especially. The vast majority of these polymers are perfluoroalkyl-substituted methacrylate copolymers.

Polyamide-amino polymers derived from polyethyleneimine by reaction with esters of perfluoroalkyl-substituted carboxylic acids are described in U.S. Pat. Nos. 3,769,307 and 3,567,500, herein incorporated by reference in their entirety.

Di-R_{F} amido monocarboxylic acids prepared from 1 equivalent of diethylenetriamine, 2 equivalents of an R_{F}-acid and 1 equivalent of an anhydride are taught for use as textile finishes in U.S. Pat. Nos. 3,754,026 and 3,646,153; all of which are herein incorporated by reference in their entirety.

Similar R_{F}-amide-substituted polyethyleneimines useful as chemically resistant surfactants are described in U.S. Pat. No. 3,271,430, herein incorporated by reference in its entirety.

Reaction products of R_{F}-substituted acids with polymers bearing pendent primary amino groups attached to a carbon-carbon backbone by a linking group are claimed in U.S. Pat. No. 4,606,973, herein incorporated by reference in its entirety.

U.S. Pat. No. 5,643,864 describes the synthesis of anionic surfactants, herein incorporated by reference in its entirety.

U.S. Pat. Nos. 5,750,043; 6,156,222; and 6,365,676 describe water-soluble R_{F}-substituted carboxylic acids that are amides of polyamines of 100 to 100,000 molecular weight which are components in aqueous fire fighting foams, herein incorporated by reference in their entirety.

U.S. Pat. Nos. 5,491,261; 5,525,732; 5,663,273 and 6,515,175 disclose certain perfluoroalkyl-substituted compounds useful for imparting oil and grease resistance to paper products; all of which are herein incorporated by reference in their entirety.

U.S. Pat. Nos. 5,329,948 and 5,427,127 disclose a method of washing dishes incorporating certain copolymers in said method, herein incorporated by reference in their entirety.

U.S. Pat. No. 7,186,300 discloses compositions and methods for treating surfaces, herein incorporated by reference in its entirety.

U.S. Pat. No. 6,037,429 discloses water-soluble fluorochemical polymers for the treatment of masonry surfaces, herein incorporated by reference in its entirety.

U.S. Pat. No. 6,271,289 discloses stain resistant compositions comprising a mixture of a fluoroalkyl phosphate and a fluoroacrylate polymer, herein incorporated by reference in its entirety.

It has now been discovered that unsaturated alkenoic acids, can be converted by reaction with a large variety of amines into mono-, di- and polyamides, which can be further reacted with non-fluorinated amino-reactive compounds such as acids, acid chlorides, esters, anhydrides, epichlorohydrin, isocyanates or urea to form monomeric and polymeric amides, amino-ethers, and ureas which are uniquely suitable—depending on their specific structure—as specialty components in hard surface cleaning compositions.

### SUMMARY OF THE INVENTION

The present invention is directed toward hard surface protectant and cleaning compositions, which comprises the following components:
(i) 0.001-25 wt-%, based on the total weight of said composition, of at least one compound selected from the group consisting of

(Q)_{z}-A-NHC(═O)—(W—R_{F})ₓ (I),

A-(Q₁-A-NHC(═O)—(W—R_{F})ₓ)_{y}—NHC(═O)—(W—R_{F})ₓ (II),
a substituted polyethyleneimine polymer of formula (VIII)

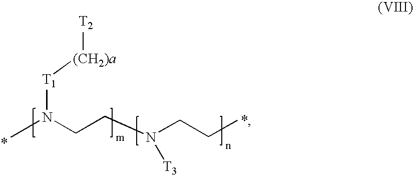

and
a substituted polyvinylamine polymer of formula (IX)

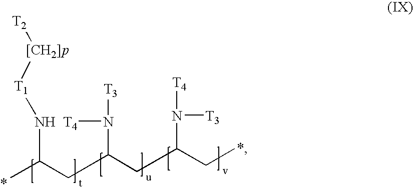

the definitions of which are described herein,
with the proviso that at least one T2, T3, T4, Q, Q1 or A contain at least one cationic group;
(ii) 0-80 wt-% based on the total weight of the composition, of at least one detergent and/or at least one soap and/or at least one salt of a saturated C₈-C₂₂ fatty acid and/or at least one unsaturated C₈-C₂₂ fatty acid;
(iii) 0-50 wt-% based on the total weight of the composition, of at least one alcohol;
(iv) 0-50 wt-% based on the total weight of the composition, of typical ingredients for cleaning composition;
(v) 0-50 wt-% based on the total weight of the composition, of at least one acid; and
(vi) tap water or deionised water ad 100 wt-%.

The present invention is also directed toward a method of hard surface cleaning and protection, which comprises contacting a surface with an effective cleaning amount of a hard surface cleaning composition containing compound according to formulae (I)-(IX) as defined above.

### DETAILED DISCLOSURE

An embodiment of the present invention is a hard surface cleaning and protectant composition comprising:
(i) 0.001-25 wt-%, based on the total weight of said composition, of at least one compound selected from the group consisting of

(Q)_{z}-A-NHC(═O)—(W—R_{F})ₓ (I),

A-(Q₁-A-NHC(═O)—(W—R_{F})ₓ)_{y}—NHC(═O)—(W—R_{F})ₓ (II),
a substituted polyethyleneimine polymer of formula (VIII)

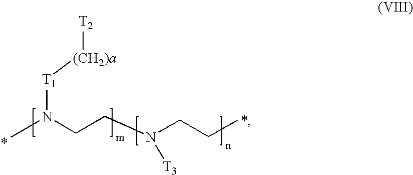

and
a substituted polyvinylamine polymer of formula (IX)

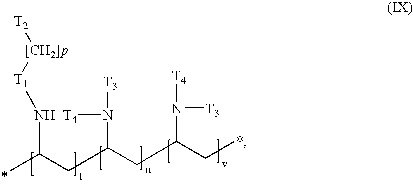

wherein
A is the hydrocarbon residue of an aliphatic, cycloaliphatic or aromatic mono-, di- or polyamine of 60 to 2000 molecular weight, which is optionally substituted by hydroxy- and/or carboxyl groups and whose carbon chain is optionally interrupted by one or more ether, amide or amino groups, which amino groups are optionally substituted by substituents of the formula -Q- or -Q₁-,
wherein
Q is a monovalent radical connected to a nitrogen atom of (A) and is derived from an acid, acid chloride or lower alkyl ester, an anhydride, a halogenated carboxylic acid, an alkyl or alkenyl halide, an oxirane compound or chloroacetamide, and which is optionally substituted by one or more hydroxy-, tert. amino or carboxyl groups, or is optionally interrupted by one or more ether or thioether linkages, and optionally contains one or more unsaturated groups and can be substituted by an R_{F} group, or is —P(═O)(OH)₂; —SO₃H; or —C(═O)—NH₂;
Q₁ is a difunctional linking group attached to the nitrogen atoms of two A groups and is derived from a diacid, diacid chloride or -lower alkyl ester; a dianhydride, a diisocyanate, epichlorohydrin, or is —C(═O)—, or is a trifunctional group derived from cyanuric acid;
each R_{F} is independently a monovalent perfluorinated alkyl or alkenyl, linear or branched organic radical having four to twenty fully fluorinated carbon atoms, or mixtures of different alkyl or alkenyl chain lengths;
W is —(CH₂)ₚCH═CH— in which p is 1 to 20, or is a C₆-C₁₀cycloaliphatic hydrocarbyl group connecting an R_{F} group to an amide carbonyl;
z is zero to 50;
y is zero to 50; and
x is 1 to 10;
T1 is a direct bond or —C(═O)—;
T2 is —CHI—CH₂—R_{F}; —CH═CH—R_{F}; —CH(OH)CH₂—O—CH₂CHI—CH₂—R_{F}; or —CH(OH)CH₂—O—CH₂CH═CH—R_{F} or mixtures thereof;
a is one to twenty;
p is one to twenty;
T3 and T4 are independently hydrogen; a C₁-C₁₈alkyl radical; a C₁-C₁₈monohydroxyalkyl radical; a C₁-C₁₈monohydroxyalkyl radical interrupted by one or more oxygen atoms; a C₁-C₁₈monohydroxyalkyl radical interrupted by one or more —N(H)—, —N(T5)-, or —N⁺(T5)(T6)(Y—)— groups; a C₁-C₁₈monohydroxyalkyl radical interrupted by one or more oxygen atoms further interrupted by alkenyl; a C₂-C₁₈poly-hydroxyalkyl radical; an aryl radical; a benzyl radical; a (C₁-C₁₈)alkylamine radical; a (C₁-C₁₈)alkylamine radical protected with a (C₁-C₁₈)alkylcarbonyl, carbamyl or (C₁-C₁₈)-alkylsulfonyl radical; a (C₁-C₁₈)alkylcarbonyl radical; a cyano(C₁-C₁₈)alkyl radical; a carbamyl(C₁-C₁₈)alkyl radical; a C₁-C₁₈trifluoroalkyl radical; a C₁-C₁₈ aminosulfonylalkyl radical; a (C₁-C₁₈)alkylcarbonyl-(C₁-C₁₈)alkyl radical; a (C₁-C₁₈)alkylsulfinyl(C₁-C₁₈)alkyl radical; a (C₁-C₁₈)alkyl-sulfonyl(C₁-C₁₈)alkyl radical; a (C₁-C₁₈)alkyl-keto-(C₁-C₁₈)alkyl; an N—(C₁-C₁₈)alkyl-aminosulfonyl(C₁-C₁₈)alkyl radical or a N—(C₁-C₁₈)alkylaminosulfonyl(C₁-C₁₈)alkyl radical;
T5 and T6 are independently hydrogen; a C₁-C₁₈alkyl radical; a C₁-C₁₈monohydroxyalkyl radical; a C₁-C₁₈monohydroxyalkyl radical interrupted by one or more oxygen atoms; a C₁-C₁₈monohydroxyalkyl radical interrupted by one or more —N(H)— groups; a C₁-C₁₈monohydroxyalkyl radical interrupted by one or more oxygen atoms further interrupted by alkenyl; a C₂-C₁₈poly-hydroxyalkyl radical; an aryl radical; a benzyl radical; a (C₁-C₁₈)alkylamine radical; a (C₁-C₁₈)alkylamine radical protected with a (C₁-C₁₈)alkylcarbonyl, carbamyl or (C₁-C₁₈)-alkylsulfonyl radical; a (C₁-C₁₈)alkylcarbonyl radical; a cyano(C₁-C₁₈)alkyl radical; a carbamyl(C₁-C₁₈)alkyl radical; a C₁-C₁₈trifluoroalkyl radical; a C₁-C₁₈ aminosulfonylalkyl radical; a (C₁-C₁₈)alkylcarbonyl-(C₁-C₁₈)alkyl radical; a (C₁-C₁₈)alkylsulfinyl(C₁-C₁₈)alkyl radical; a (C₁-C₁₈)alkyl-sulfonyl(C₁-C₁₈)alkyl radical; a (C₁-C₁₈)alkyl-keto-(C₁-C₁₈)alkyl; an N—(C₁-C₁₈)alkyl-aminosulfonyl(C₁-C₁₈)alkyl radical or a N—(C₁-C₁₈)alkylaminosulfonyl(C₁-C₁₈)alkyl radical;
   In formula (VIII),
   m is 0.0001-99.9999 weight percent of the total polymer;
   n is 0.0001-99.9999 weight percent of the total polymer;
   In formula (IX),
   t is 0.0001-99.9998 weight percent of the total polymer;
   u is 0.0001-99.9998 weight percent of the total polymer;
   v is 0.0001-99.9998 weight percent of the total polymer;
with the proviso that at least one T2, T3, T4, Q, Q1, or A contains at least one cationic group;
(ii) 0-80 wt-% based on the total weight of the composition, of at least one detergent and/or at least one soap and/or at least one salt of a saturated C₈-C₂₂ fatty acid and/or at least one unsaturated C₈-C₂₂ fatty acid;
(iii) 0-50 wt-% based on the total weight of the composition, of at least one alcohol;
(iv) 0-50 wt-% based on the total weight of the composition, of typical ingredients for cleaning composition;
(v) 0-50 wt-% based on the total weight of the composition, of at least one acid; and
(vi) tap water or deionised water ad 100 wt-%.

In another embodiment of the instant invention, component (i) is from about 0.01 to about 10 wt % based on the total weight of the composition.

In another embodiment of the instant invention, component (i) is from about 0.1 to about 5 wt % based on the total weight of the composition.

In another embodiment of the instant invention, component (ii) is from about 0.01 to about 25 wt % based on the total weight of the composition.

In another embodiment of the instant invention, component (ii) is from about 0.1 to about 10 wt % based on the total weight of the composition.

In another embodiment of the instant invention, component (iii) is from about 0.01 to about 45 wt % based on the total weight of the composition.

In another embodiment of the instant invention, component (iii) is from about 0.01 to about 25 wt % based on the total weight of the composition.

In another embodiment of the instant invention, component (iv) is from about 0.01 to about 45 wt % based on the total weight of the composition.

In another embodiment of the instant invention, component (iv) is from about 0.1 to about 35 wt % based on the total weight of the composition.

In another embodiment of the instant invention, component (v) is from about 0.01 to about 45 wt % based on the total weight of the composition.

In another embodiment of the instant invention, component (v) is from about 0.1 to about 25 wt % based on the total weight of the composition.

The compounds of the present invention preferably have a number average molecular weight of 1,000 to 100,000.

A cationic group is defined as a primary (—NH2), secondary (—NHT5), or tertiary (—NT5T6) amine salt of an HY acid or a quarternary ammonium group (—N+T3T4T5)Y—.

HY is an inorganic or organic acid; wherein the total charge of cations is equal to the total charge of anions.

For example, Y is phosphate, phosphonate, carbonate, bicarbonate, nitrate, chloride, bromide, bisulfite, sulfite, bisulfate, sulfate, borate, formate, acetate, benzoate, citrate, oxalate, tartrate, acrylate, polyacrylate, fumarate, maleate, itaconate, glycolate, gluconate, malate, mandelate, tiglate, ascorbate, polymethacrylate, a carboxylate of nitrilotriacetic acid, a carboxlylate of hydroxyethylethylenediaminetriacetic acid, a carboxylate of ethylenediaminetetraacetic acid, a carboxylate of diethylenetriaminepentaacetic acid, a carboxylate of diethylenediaminetetraacetic acid, a carboxylate of diethylenetriaminepentaacetic acid, alkylsulfonate, arylsulfonate, or alkyl-substituted arylsulfonate.

Y is a carboxylate, especially a carboxylate of a mono-, di-, tri- or tetracarboxylic acid, mainly of 1-18 carbon atoms, such as a formate, acetate, benzoate, citrate, or oxalate.

For example, Y is chloride, bisulfate, sulfate, phosphate, nitrate, ascorbate, formate, acetate, benzoate, oxalate, citrate, a carboxylate of ethylenediaminetetraacetic acid or of diethylene-triaminepentaacetic acid or polyacrylate.

For instance, Y is chloride, bisulfate, ascorbate, or citrate.

The total charge for the salt is neutral. For example, the total number of cations is equal to the total number of anions.

In another embodiment of the instant invention, W is of the formula —(CH₂)ₚCH═CH— in which p is 5 to 12 and is derived from a terminally unsaturated alkenoic acid, or is derived from tetrahydrophthalic anhydride or (methyl)-norbornene anhydride; R_{F} is saturated and contains 4-14 carbon atoms, is fully fluorinated and contains at least one terminal perfluoromethyl group.

In another embodiment of the instant invention, W is of the formula —(CH₂)ₚCH═CH— in which p is 8, and R_{F} is saturated and contains 6-12 fully fluorinated carbon atoms.

In another embodiment of the instant invention, when A is the hydrocarbon residue of an optionally substituted and/or interrupted monoamine, the amine is an amino acid such as glycine, p-aminosulfonic acid or taurine, or an amino alcohol such as 2-hydroxyethanolamine or is a tert. amino-substituted amine residue of the formula —(CH₂)ⱼ—N—(R₁)₂ wherein j is 2 to 6 and each R₁ is independently C₁-C₄alkyl, such as N,N-dimethylpropane-1,3-diamine. In another embodiment of the instant invention, a compound of the formula (II) is wherein A is a tert. amino-substituted amine residue of the formula —(CH₂)ⱼ—N—(R₁)₂ wherein j is 2 to 6 and each R₁ is independently C₁-C₄alkyl, W is of the formula —(CH₂)ₚCH═CH— in which p is 8, and R_{F} is saturated and contains 6-12 fully fluorinated carbon atoms.

In another embodiment of the instant invention, when A is the hydrocarbon residue of an optionally substituted and/or interrupted diamine, the diamine is of the formula H₂N—(CH₂)ₙ—NH₂ wherein n is 2-6, or is p-phenylenediamine, lysine, or a diamine of the formula H₂N—(CH₂)₃—O—(CH₂—CH₂—O)ₘₘ—(CH₂—CHCH₃—O)_{II}—(CH₂)₃—NH₂, wherein mm and II are independently 0 to 50 and mm plus II is ≧1.

In another embodiment of the instant invention, when A is the hydrocarbon residue of an optionally substituted and/or interrupted polyamine, the amine is a polyalkyleneamine of the formula H₂N—(CH₂CHR—NH)ₙ—CH₂CHR—NH₂, wherein n is 1 to 5 and R is hydrogen or methyl, or is aminoethylpiperazine, iminobispropylamine or N,N′-bis(3-aminopropyl)ethylenediamine, or is a polyethyleneimine of molecular weight 200 to 10,000 or polylysine.

In another embodiment of the instant invention, A is derived from a polyethyleneimine of molecular weight 200 to 1,000, diethylenetriamine, triethylenetetramine, N,N′-bis(3-aminopropyl)ethylenediamine, lysine or polylysine.

In another embodiment of the instant invention, Q is of formula —C(═O)CH₃; —(CH₂)₁₋₃COOH; —C(═O)—CR═CH₂, wherein R is hydrogen or methyl; —CH₂CH═CH₂; —CH₂CH(OH)CH₂—O—CH₂CH═CH₂; —CH₂CH═CH—R_{F} or —CH₂CH(OH)CH₂—O—CH₂—CH═CH—R_{F}, where R_{F} is defined as above; —C(═O)—(CH₂)₂—COOH; —C(═O)—CH═CH—COOH; —C(═O)—C(═CH₂)—CH₂—COOH; —C(═O)—CH₂—C(═CH₂)—COOH; —C(═O)—(C₆H₈)—COOH; —C(═O)—(C₇H₈)—COOH; —C(═O)—(C₈H₁₀)—COOH; —C(═O)—(CH₂)₈CH═CH₂; —CH₂—CHOH—CH₂—O—(CH₂ CHR—O)ₘ—R₂ where m is 1 to 50 and R₂ is hydrogen or C₁-C₁₂alkyl; —P(═O)(OH)₂; —SO₃H; or —CH₂CH₂N(CH₃)₂.

In another embodiment of the instant invention, Q is of formulae —C(═O)CH₃; —C(═O)—CH═CH₂; —CH₂—COOH; —C(═O)—(CH₂)₂—COOH and —C(═O)—(C₆H₈)—COOH.

In another embodiment of the instant invention, Q₁ is of formula —(C═O)—HN-Z-NHC(═O)—, wherein Z is the diradical hydrocarbon residue of p- or m-toluene diisocyanate, isophorone diisocyanate, 3,3,4(3,4,4)-trimethylhexane-1,6-diisocyanate or hexane-1,6-diisocyanate; —C(═O)—; —CH₂—CHOH—CH₂— or —CH₂—CHOH—CH₂—O—(CH₂ CH₂—O)ₘ—(CH₂ CHCH₃—O)_{I}—CH₂—CHOH—CH₂—, wherein m and I are independently 0 to 50 and m plus I is ≧1; —C(═O)—C₆H₄(—COOH)₂—C(═O)—; or —C(═O)—CH₂C(═CH₂)—C(═O)— or —C(═O)-D-C(═O)—, wherein D is the hydrocarbon residue of an aliphatic or aromatic dicarboxylic acid having from 2 to 10 carbon atoms.

In another embodiment of the instant invention, Q₁ is of formula —CH₂—CHOH—CH₂—;—C(═O)—C₆H₄(—COOH )₂—C(═O)—;—C(═O)—CH₂CH₂—C(═O)— or —C(═O)HN-Z-NHC(═O)— wherein Z is the diradical residue of p- or m-toluene diisocyanate, isophorone diisocyanate, 3,3,4(3,4,4)-trimethylhexane-1,6-diisocyanate or hexane-1,6-diisocyanate.

In another embodiment of the instant invention, compounds of the formula (I) are of the formula

Q_{z}-A-(C(═O)—(CH₂)₈CH═CH—R_{F})₂ (II),

wherein

A is derived from diethylenetriamine, triethylenetetramine or N,N′-bis(3-aminopropyl)ethylene-diamine, Q is —C(═O)CH₃; —C(═O)—CH═CH₂; —CH₂—COOH; —C(═O)—(CH₂)₂—COOH or —C(═O)—(C₆ H₈)—COOH, z is 1 or 2, and each R_{F} is independently a monovalent perfluorinated linear alkyl radical having 6 to 14 fully fluorinated carbon atoms.

In another embodiment of the instant invention, compounds of the formula (II) are of formula

(Q₁-A-NH—C(═O)—(CH₂)₈CH═CH—R_{F})₂-A-(NH—C(═O)—(CH₂)₈CH═CH—R_{F})₂ (IV),

wherein A is derived from diethylenetriamine and Q₁ is a difunctional radical of the formula —CH₂—CHOH—CH₂—; —C(═O)—CH₂CH₂—C(═O)—; —C(═O)—; —C(═O)—C₆H₄(—COOH)₂—C(═O)—, or —C(═O)—NH-Z-NH—C(═O)—, wherein Z is the diradical hydrocarbon residue of p- or m-toluene diisocyanate, isophorone diisocyanate, 3,3,4(3,4,4)-trimethylhexane-1,6-diisocyanate or hexane-1,6-diisocyanate and each R_{F} is independently a monovalent perfluorinated linear alkyl radical having 6 to 14 fully fluorinated carbon atoms; in another embodiment of the instant invention, a dimeric compound of the formula

(R_{F}—CH═CH(CH₂)₈C(═O)—NH)₂-A-Q₁-A-(NHC(═O)(CH₂)₈CH═CH—R_{F})₂ (V),

wherein R_{F}, A and Q₁ are as defined above.

In another embodiment of the instant invention, compounds of the formula (II) are of the formula

A-(Q₁-A-(NHC(═O)(CH₂)₈CH═CH—R_{F})₂)_{y}—(NHC(═O)(CH₂)₈CH═CH—R_{F})₂ (VI),

wherein

y is 2 to 50, A is derived from triethylenetetramine or N′N-bis(3-aminopropyl)ethylenediamine and difunctional Q₁ is of the formula —CH₂—CHOH—CH₂—, —C(═O)—CH₂CH₂—C(═O)—; —C(═O)—, —C(═O)—C₆H₄(—COOH)₂—C(═O)—, or —C(═O)—HN-Z-NH—C(═O)—, wherein Z is the diradical hydrocarbon residue of p- or m-toluene diisocyanate, isophorone diisocyanate, 3,3,4(3,4,4)-trimethylhexane-1,6-diisocyanate or hexane-1,6-diisocyanate, thus describing polymers of formula

(R_{F}—CH═CH(CH₂)₈(C═O)HN)₂-A-(Q₁-A-(NHC(═O)(CH₂)₈CH═CH—R_{F})₂)_{y} (VII)

which are polyamides, polyureas or poly-tert. amines.

The compounds of the formula (I)-(IX) can be synthesized in various ways. In one method, an aliphatic, cycloaliphatic or aromatic mono-, di- or polyamine is in a first step reacted with an R_{F}-acid, -ester or -anhydride at temperatures of 50 to 260° C., depending on the reactivity of the acid or ester, to form the corresponding R_{F}-amide intermediate which may contain unreacted secondary amino groups.

This amidification reaction is preferably carried out in bulk, but aprotic diluents can be present. Preferably, a catalyst such as phosphoric acid is employed.

In a second step any remaining—mostly secondary—amino groups are reacted with an amino-reactive non-fluorinated compound. Useful reactants to convert remaining unreacted amino groups include anhydrides such as acetic anhydride, succinic and maleic anhydride, methendic and phthalic or tetrahydrophthalic anhydride; C₁-C₈carboxylic acids and their methyl esters; chloroacetic acid; alkyl halides such as allyl chloride; allyl glycidyl ether, urea and isocyanates.

If the reactants are difunctional reactants they can act as chain-extending agents. Typical of such compounds are diacids and their lower alkyl esters, such as glutaric acid and dimethylsuccinate or dimethyladipate, or anhydrides such as succinic and maleic anhydride, methendic and phthalic anhydride, also dianhydrides such as benzene- and benzophenone tetracarboxylic acid dianhydride; epichlorohydrin; urea, and aliphatic, cycloaliphatic and aromatic diisocyanates with 6 to 2 carbon atoms, such as 1,6-hexane diisocyanate, 2,2,3(2,3,3)-trimethylhexane-1,6-diisocyante, cyclohexane diisocyanate, isophorone diisocyanate and toluene diisocyanate. If the starting polyamine (P) is for example N,N′-bis-(3-aminopropyl) ethylenediamine, or a polyethyleneimine, the resulting reaction products are polyureas and polyamides.

In an alternate process, a linear terminally-unsaturated monocarboxylic acid or its lower alkyl ester, or tetrahydrophthalic anhydride is first reacted with a polyamine, to form an oligoamide with residual secondary amino groups. Preferably this reaction is carried out without a solvent. Although it is possible to use other linear terminally-unsaturated monocarboxylic acids, 10-undecenoic acid or its lower alkyl ester is preferred because R_{F} substituents which are attached to the amino group through an intervening undecenoic group aid in the orientation of the R_{F} groups and thereby improve their effectiveness as cleaning agents.

In a second step, the remaining secondary amino groups are reacted with an amino-reactive non-fluorinated compound of the type described above to form a fully substituted intermediate. Finally, this ethylenically unsaturated intermediate is reacted with an R_{F}-iodide using a free radical generating mechanism as described for instance in U.S. Pat. Nos. 5,585,517; 5,693,747; and 6,436,235.

Substituents —CH₂CH═CH—R_{F} or —CH₂CH(OH)CH₂—O—CH₂—CH═CH—R_{F}, where R_{F} is defined as above can be incorporated into the compound by reaction of amino groups with allyl chloride or allyl glycidyl ether at any convenient stage during the synthesis, but before the addition of the R_{F}-iodide.

Halogen-containing compounds, such as allyl chloride, mono-chloroacetic acid, chloromethyl benzene, xylylene dichloride, or methyl iodide or bromide can be further used for quaternization of tertiary amino groups. Tertiary amino groups are always present in polyethyleneimines, and also if allyl chloride or allyl glycidyl ether are used as co-reactants.

The final product mixture is then diluted, if desired, with sufficient deionized water to adjust the solids content to 15 to 50% and the fluorine content to 4 to 10%. Thus another aspect of the present invention is an essentially aqueous solution comprising 15 to 50% of a compound of the formula (I)-(IX) as defined above.

The groups defined within n of formula (VIII) and/or the groups defined within u and/or v of formula (IX) may contain amine salts of protic acids or quarternized nitrogen atoms.

As component (ii), anionic, nonionic, or zwitterionic and amphoteric synthetic detergents are suitable.

Suitable anionic detergents are
sulfates, for example fatty alcohol sulfates, the alkyl chain of which has from 8 to 18 carbon atoms, for example sulfated lauryl alcohol;
fatty alcohol ether sulfates, for example the acid esters or salts thereof of a polyaddition product of from 2 to 30 mol of ethylene oxide and 1 mol of a C₈-C₂₂ fatty alcohol;
the alkali metal, ammonium or amine salts, referred to as soaps, of C₈-C₂₀ fatty acids, for example coconut fatty acid;
alkylamide sulfates;
alkylamine sulfates, for example monoethanolamine lauryl sulfate;
alkylamide ether sulfates;
alkylaryl polyether sulfates;
monoglyceride sulfates;
alkanesulfonates, the alkyl chain of which contains from 8 to 20 carbon atoms, for example dodecyl sulfonate;
alkylamide sulfonates;
alkylaryl sulfonates;
α-olefin sulfonates;
sulfosuccinic acid derivatives, for example alkyl sulfosuccinates, alkyl ether sulfosuccinates or alkylsulfosuccinamide derivatives;
   N-[alkylamidoalkyl]amino acids of formula

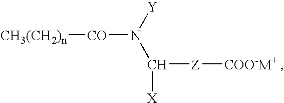

wherein
   X is hydrogen, C₁-C₄alkyl or —COO-M+,
Y is hydrogen or C₁-C₄alkyl,
   Z is

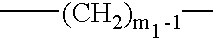

m₁ is from 1 to 5,
n is an integer from 6 to 18 and
M is an alkali metal cation or amine cation, alkyl and alkylaryl ether carboxylates of formula CH₃—X—Y-A wherein
X is a radical of formula

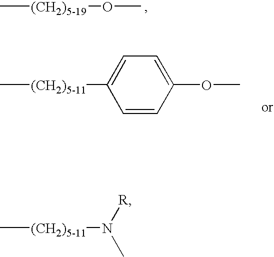

R is hydrogen or C₁-C₄alkyl,
Y is —(CHCHO)₁₋₅₀—,
A is (CH₂)ₘ₂₋₁—COO-M⁺,
m₂ is from 1 to 6 and
M is an alkali metal cation or amine cation.

Also used as anionic surfactants are fatty acid methyl taurides, alkyl isothionates, fatty acid polypeptide condensation products and fatty alcohol phosphoric acid esters. The alkyl radicals occurring in those compounds preferably have from 8 to 24 carbon atoms.

The anionic surfactants are generally in the form of their water-soluble salts, such as the alkali metal, ammonium or amine salts. Examples of such salts include lithium, sodium, potassium, ammonium, triethylamine, ethanolamine, diethanolamine and triethanolamine salts. The sodium, potassium or ammonium (NR₄R₅R₆) salts, especially, are used, with R₄, R₅ and R₆ each independently of the others being hydrogen, C₁-C₄alkyl or C₁-C₄hydroxyalkyl.

Especially preferred anionic surfactants in said composition according to the invention are monoethanolamine lauryl sulfate or the alkali metal salts of fatty alcohol sulfates, especially sodium lauryl sulfate and the reaction product of from 2 to 4 mol of ethylene oxide and sodium lauryl ether sulfate.

Zwitterionic detergents contain both basic and acidic groups which form an inner salt giving the molecule both cationic and anionic hydrophilic groups over a broad range of pH values. Some common examples of these detergents are described in U.S. Pat. Nos. 2,082,275; 2,702279; and 2,255,082, incorporated herein by reference. Suitable zwitterionic detergent compounds have the formula

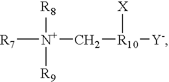

wherein

R₇ is an alkyl radical containing from about 8 to about 22 carbon atoms,

R₈ and R₉ are independently from each other alkyl radical containing from 1 to about 3 carbon atoms,

R₁₀ is an alkylene chain containing from 1 to about 3 carbon atoms,

X is selected from the group consisting of hydrogen and a hydroxyl radical,

Y is selected from the group consisting of carboxyl and sulfonyl radicals and

wherein the sum of the R₇, R₈ and R₉ radicals is from about 14 to about 24 carbon atoms.

Amphoteric and ampholytic detergents which can be either cationic or anionic depending upon the pH of the system are represented by detergents such as dodecyl-beta-alanine, N-alkyltaurines such as the one prepared by reacting dodecylamine with sodium isothionate according to the teaching of U.S. Pat. No. 2,658,072, N-higher alkylaspartic acids such as those produced according to the teaching of U.S. Pat. No. 2,438,091, and the products sold under the trade name “Miranol,” and described in U.S. Pat. No. 2,528,378, said patents being incorporated herein by reference.

Further suitable zwitterionic and amphoteric surfactants include C₈-C₁₈betaines, C₈-C₁₈sulfobetaines, C₈-C₂₄alkylamido-C₁-C₄alkylenebetaines, imidazoline carboxylates, alkylamphocarboxycarboxylic acids, alkylamphocarboxylic acids (e.g. lauroamphoglycinate) and N-alkyl-β-aminopropionates or -iminodipropionates, with preference being given to C₁₀-C₂₀alkylamido-C₁-C₄alkylenebetaines and especially to coconut fatty acid amide propylbetaine. Nonionic surfactants that may be mentioned include, for example, derivatives of the adducts of propylene oxide/ethylene oxide having a molecular weight of from 1000 to 15000, fatty alcohol ethoxylates (1-50 EO), alkylphenol polyglycol ethers (1-50 EO), polyglucosides, ethoxylated hydrocarbons, fatty acid glycol partial esters, for example diethylene glycol monostearate, fatty acid alkanolamides and dialkanolamides, fatty acid alkanolamide ethoxylates and fatty amine oxides. Nonionic synthetic detergents comprise a class of compounds which may be broadly defined as compounds produced by the condensation of alkylene oxide groups (hydrophilic in nature) with an organic hydrophobic compound, which may be aliphatic or alkyl aromatic in nature. The length of the hydrophilic or polyoxyalkylene radical which is condensed with any particular hydrophobic group can be readily adjusted to yield a water-soluble compound having the desired degree of balance between hydrophilic and hydrophobic elements.

As component (ii) there may also be used the salts of saturated and unsaturated C₈-C₂₂ fatty acids (soap) either alone or in the form of a mixture with one another or in the form of a mixture with other detergents mentioned as component (ii). Examples of such fatty acids include, for example, capric, lauric, myristic, palmitic, stearic, arachidic, behenic, caproleic, dodecenoic, tetradecenoic, octadecenoic, oleic, eicosenoic and erucic acid, and the commercial mixtures of such acids, such as, for example, coconut fatty acid. Such acids are present in the form of salts, there coming into consideration as cations alkali metal cations, such as sodium and potassium cations, metal atoms, such as zinc and aluminum atoms, and nitrogen-containing organic compounds of sufficient alkalinity, such as amines and ethoxylated amines. Such salts may also be prepared in situ.

The fatty acids used in making the soaps can be obtained from natural sources such as, for instance, plant or animal-derived glycerides (e.g., palm oil, coconut oil, babassu oil, soybean oil, castor oil, tallow, whale oil, fish oil, tallow, grease, lard and mixtures thereof). The fatty acids can also be synthetically prepared (e.g., by oxidation of petroleum stocks or by the Fischer-Tropsch process).

Alkali metal soaps can be made by direct saponification of the fats and oils or by the neutralization of the free fatty acids which are prepared in a separate manufacturing process. Particularly useful are the sodium and potassium salts of the mixtures of fatty acids derived from coconut oil and tallow, i.e., sodium and potassium tallow and coconut soaps.

The term “tallow” is used herein in connection with fatty acid mixtures which typically have an approximate carbon chain length distribution of 2.5% C₁₄, 29% C₁₆, 23% C₁₈, 2% palmitoleic, 41.5% oleic and 3% linoleic (the first three fatty acids listed are saturated). Other mixtures with similar distribution, such as the fatty acids derived from various animal tallows and lard, are also included within the term tallow. The tallow can also be hardened (i.e., hydrogenated) to convert part or all of the unsaturated fatty acid moieties to saturated fatty acid moieties.

When the term “coconut oil” is used herein it refers to fatty acid mixtures which typically have an approximate carbon chain length distribution of about 8% C₈, 7% C₁₀, 48% C₁₂, 17% C₁₄, 9% C₁₆, 2% C₁₈, 7% oleic, and 2% linoleic (the first six fatty acids listed being saturated). Other sources having similar carbon chain length distribution such as palm kernel oil and babassu oil are included with the term coconut oil.

As component (iii) there come into consideration as dihydric alcohols especially those compounds having from 2 to 6 carbon atoms in the alkylene moiety, such as ethylene glycol, 1,2- or 1,3-propanediol, 1,3-, 1,4- or 2,3-butanediol, 1,5-pentanediol and 1,6-hexanediol. Preference is given to 1,2-propanediol (propylene glycol).

As component (iii), preferred monohydric alcohols are ethanol, n-propanol and isopropanol and mixtures of those alcohols.

As component (iv), the hard surface cleaning compositions may further comprise conventional ingredients known to be used therein. Such ingredients may be perfumes; colorants; bactericide; enzymes such as protease; dyes; chelants; viscosity modifiers, such as xanthan gum or polymeric viscosity modifiers; pigments; solvents; corrosion inhibitors; preservatives; antioxidants; ultraviolet absorbers; sunscreens; hydrotropes; and builder such as carboxylic acid detergent including citric and tartaric acids.

Exemplary acids uses as component (v) compositions of the present invention include, without limitation, citric, sulfuric, hydrochloric, phosphoric, acetic, hydroxyacetic, and sulfamic acids.

The instant hard surface cleaning compositions are useful as acidic household compositions. Acidic household compositions can be any common known formulations, such as general-purpose cleaners for cleaning hard surfaces, acid household cleaners (bath) or WC cleaners.

The hard surface cleaning compositions may be applied as a ready-to-use spray, liquid or paste, directly on the surface, which is then wiped using a paper towel, sponge, cloth, mop or other suitable wiping implement. Alternatively, the composition may be applied first to the wiping implement and then to the surface. The composition may also be supplied in a dilutable form that is a solid or liquid concentrate that may be diluted with water to arrive at the final cleaning composition. For example, it may be in the form of a dilutable powdered or granular formulation, or a tablet, pouch or sachet.

The hard surface cleaning compositions may be added to a wipe or pad, either reusable or disposable, which is then used to treat the surface by wiping. The composition is absorbed into or adsorbed onto the wipe or pad, that is to say, the wipe or pad is impregnated with the aqueous cleaning composition. Such a wipe may be constructed of natural or synthetic fibers, for example cellulosic, polyester, polyolefin, woven or non-woven fibers, or any other material or combination of materials suitable for making a wiping cloth as is known by those skilled in the art. Such wiping cloths typically are constructed out of non-woven type materials. Polyolefin is for example polypropylene or polypropylene copolymers or blends. Cellulosic means cellulose-based.

The instant hard surface cleaning compositions containing compounds of formulae (I)-(IX) in a cleaning formulation will typically give a pH of 3 to 12, preferably from 4 to 11.

The invention further relates to a method of hard surface cleaning, which comprises contacting a surface with an effective amount of a cleaning formulation according to the invention. Said methods of cleaning hard surfaces give improved soil removal properties as well as resistance to soiling and staining.

In one such method, the cleaning formulation according to the invention is sprayed onto a soiled hard surface. The wetted surface is then wiped clean using a paper towel or other suitable applicator tool. This initial cleaning process will cause the instant compounds of the invention to deposit onto the hard surface, forming an invisible film. After subsequent re-soiling of the surface, the soil will be more easily removed than in the case where the cleaning formulation according to invention was not used in the initial cleaning step. The surface may also remain cleaner longer than an untreated surface because the easier cleaning property conferred by the cleaning formulation according to invention will tend to prevent soil from adhering to the surface in general.

In an alternative method of application, the cleaning formulation of the invention can be applied to a clean surface as a pre-treatment step, causing the instant compounds to adhere to the surface as an invisible film. The surface will also be resistant to soiling and will be easier to clean in subsequent steps, compared to a similar surface that was not treated with the cleaning composition of this invention. Thus the invention further relates to a method of treating a hard surface whereby resistance to soiling and ease of subsequent soil removal is improved, which comprises contacting said hard surface with an effective amount of a formulation according to the invention.

The hard surface cleaning compositions or formulations can be used on many different surface types, such as ceramic tile, stone, glass, cement, concrete, plastic, polyurethane, bricks, plaster (for example, walls), marble and masonry; countertops of stone, marble or plastic; and wood, laminates or other types of floors made of organic or inorganic materials.

A preferred embodiment of the present invention relates to aqueous hard surface cleaning compositions, which are transparent.

The actual active ingredient and the actual minimum effective amount will be determined by the actual product/application in which the hard surface cleaning composition is to be used.

The following examples describe certain embodiments of this invention, but the invention is not limited thereto. It should be understood that numerous changes to the disclosed embodiments could be made in accordance with the disclosure herein without departing from the spirit or scope of the invention. These examples are therefore not meant to limit the scope of the invention. Rather, the scope of the invention is to be determined only by the appended claims and their equivalents. In these examples all parts given are by weight unless otherwise indicated.

The following examples illustrate the invention.

In the Instant Examples, all parts are by weight unless otherwise specified. Perfluoroalkyl iodides CₙF₂ₙ₊₁—I with n=4 to 14 are obtained from DuPont under the product names ZONYL® PFBI, ZONYL® TELA-L and ZONYL® TEL A-N. They have the following average telomer distributions:

ZONYL® PFBI: C₄ only;

ZONYL® TELA-L: C₄=4% maximum, C₆=50±3%, C₈=29±2%, C₁₀=11±2%, C₁₂=4±1%, C₁₄ and higher=2% maximum; and,

ZONYL® TELA-N: C₆=6% max, C₈=50±3%, C₁₀=29±2%, C₁₂=11±1% C₁₄ and higher=4% maximum.

The corresponding perfluoroalkylethyl iodides, CₙF₂ₙ₊₁—CH₂CH₂I, are available from DuPont under the product name ZONYL® PFBEI, ZONYL® TELB-L and TELB-N and have essentially the same telomer chain length distribution as TELA-L and -N.

Analytical Methods

Progress of the reaction of allyl glycidyl ether with polyethylenimine is followed by gas chromatography. The reaction is allowed to continue until allyl glycidyl ether is no longer detected.

ZONYL® TELA-L consumption is also followed by gas chromatography using an HP 5890 GC and a Supelco SPB-1, 60 mesh/0.53mm by 3.0 m column with FID detector.

Determination of Ionic Chloride and Iodide is done by titration as described below:

Equipment: Brinkmann Auto Titrator, Model E436; Fisher Ag/AgCl Reference Electrode;

Fisher Silver Billet Indicating Electrode; and, Aldrich Standard AgCl.

Procedure: 1) Weigh about a 0.2 g sample for chloride or 1.0 g for iodide into a 200 ml Beaker and dilute with 150 ml of water and add 1 ml of glacial acetic acid. 2) Titrate with 0.1023 M AgNO₃ at 750 mv and a speed of “2”.

$$Calculation \text{:}$$

$$\% Conversion ( based on {CI}^{-} ) = \frac{ml \times M \times ( Total R \times n Mass ) \times 100 \%}{( g sample ) ( mmol of Chloroacetic acid )}$$

$$\% Conversion ( based on I - ) = \frac{ml \times M \times ( Total R \times n Mass ) \times 100 \%}{( g sample ) ( mmol of {R}_{F} I )}$$

### EXAMPLE 1

### Reaction product of N,N′-Bis(3-(11-perfluoroalkyl, 10-undecylenamido)propyl)ethylenediamine and Glycidyltrimethylammonium chloride

### 1A: Diamide from 10-undecenoic acid and N,N′-Bis(3-aminopropyl)ethylenediamine

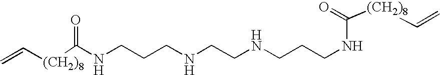

N,N′-Bis (Aminopropyl)ethylenediamine (30.0 g, 161.8 mmol, 94% assay, Aldrich) and undecylenic acid (59.6 g, 323.6 mmol, 98% assay, Acros) are placed into a round-bottomed flask equipped with a stirrer, nitrogen inlet and a thermoregulator. This mixture is heated with stirring. The reaction mixture is then stirred for 5 hours at 170 C. Consumption of undecylenic acid is monitored by gas chromatography. Typically, this product is not isolated but used directly in the next step.

### 1B: N,N′-Bis(3-(11-perfluoroalkyl, 10-undecylenamido)propyl)ethylenediamine

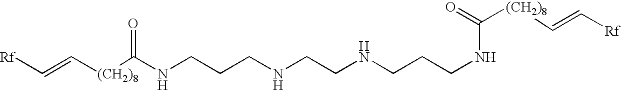

The compound from Example 1A (25.0 g, 49.3 mmol) is placed into a round-bottomed flask equipped with a stirrer, nitrogen inlet and a thermoregulator and heated. When the temperature reaches 40 C, 15.7 g of 2-propanol and 11.1 g of deionized water are added to the flask. Sodium hydroxide (5.0 g, 62.5 mmol, 50% assay) is then added to the mixture. The temperature is then raised to 80 C, and perfluoroalkyl iodide (ZONYL TELA-N, 58.2 g, 96.68 mmol) and sodium metabisulfite (0.94 g, 4.94 mmol) are added along with 2,2′-azobisisobutyronitrile (0.4 g, 2.4 mmol). A temperature increase from 71-78 C is observed. When the rise in temperature subsides, the reaction mixture is maintained at 80 C for 5 hours with stirring. After five hours, the mixture is cooled to 70 C and sampled for reaction completion. Conversion of R_{F}-iodide, as determined by gas chromatography, is >99%. Sodium hydroxide (5.0 g, 62.5 mmol, 50% assay) is added to the mixture. Completion of the dehydrohalogenation reaction is determined by chloride titration with silver nitrate. After two hours, 10 g of diethylketone and 90 g of deionized water is added to wash any salt from the mixture. The top layer is removed and the washing process is repeated once. The sample is then oven dried at 50° C. under vacuum to yield a brown solid.

### 1C: Reaction product of N,N′-Bis(3-(11-perfluoroalkyl, 10-undecylenamido)propyl)ethylenediamine and Glycidyltrimethylammonium chloride

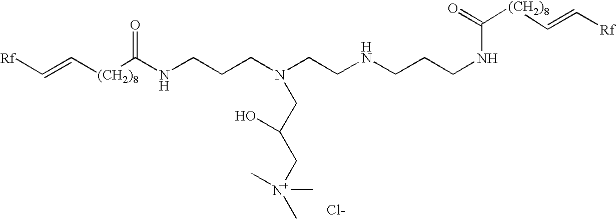

The compound from Example 1B (20 g,13.9 mmol) is placed into a round-bottomed flask equipped with a stirrer, nitrogen inlet and a thermoregulator and heated. When the temperature reaches 40 C, 7.6 g of 2-propanol and 10 g of deionized water are added to the flask. Glycidyltrimethylammonium chloride (Quab 151, 5.6 g, Degussa, 38% solids) is added. The reaction mixture temperature is maintained at 60 C for 5 hours with stirring. After five hours, a semi viscous clear yellow mixture is obtained. Deionized water (106.1 g) is added to the flask along with 12.6 g of a 3% HCL solution. An aliquot of the reaction mass is then oven dried at 50 C under vacuum to determine the percent solids; an assay of 14.7% solids is determined.

### EXAMPLE 2

### Reaction product of N,N′-Bis(3-(11-perfluorobutyl, 10-undecylenamido)propyl)ethylenediamine and Glycidyltrimethylammonium chloride

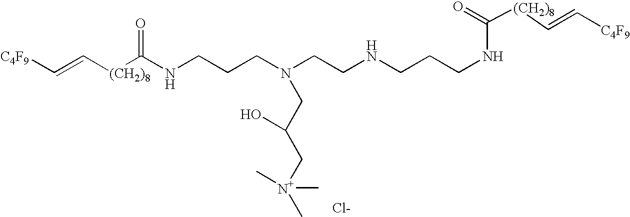

Following the procedure of Example 1B, a product is synthesized using Perfluorobutyl iodide (99%) instead of Zonyl TEL AN. This sample is further reacted following example 1C to yield the desired product.

### EXAMPLE 3

### Reaction product of N,N′-Bis(3-(11-perfluoroalkyl, 10-undecylenamido)propyl)ethylenediamine and 3-chloro-2-hydroxypropyl-N, N,N-dimethyloctadecylammonium chloride

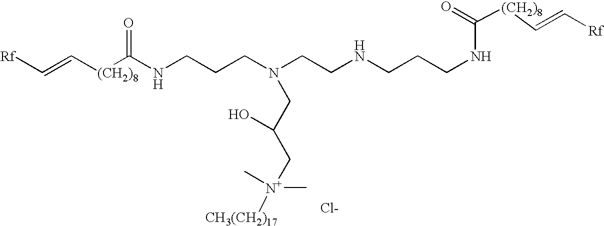

Following the procedure of Example 1C, a product is synthesized using 3-chloro-2-hydroxypropyl-N, N,N-dimethyloctadecylammonium chloride (Quab 426 from Degussa, 38% actives) instead of glycidyltrimethylammonium chloride (Quab 151 from Degussa).

### EXAMPLE 4

### Reaction product of N,N′-Bis(3-(11-perfluoroalkyl, 10-undecylenamido)propyl)ethylenediamine and 3-chloro-2-hydroxypropyl-N, N,N-dimethyldodecylammonium chloride

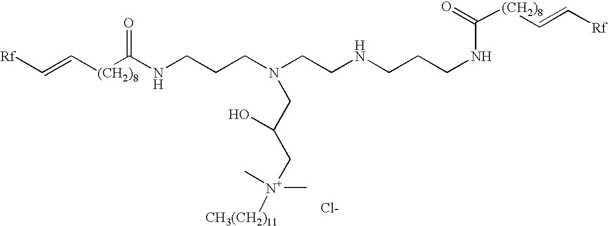

Following the procedure of Example 1C, a product is synthesized using 3-chloro-2-hydroxypropyl-N, N,N-dimethyldodecylammonium chloride (Quab 342 from Degussa, 38% actives) instead of glycidyltrimethylammonium chloride (Quab 151 from Degussa).

### EXAMPLE 5

### Reaction product of N,N′-Bis(3-(11-perfluorobutyl, 10-undecylenamido)propyl)ethylenediamine and 3-chloro-2-hydroxypropyl-N, N,N-dimethyldodecylammonium chloride

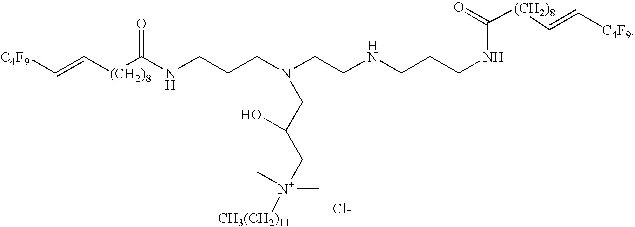

Following the procedure of Example 2, a product is synthesized using 3-chloro-2-hydroxypropyl-N, N,N-dimethyldodecylammonium chloride (Quab 342 from Degussa, 38% actives) instead of glycidyltrimethylammonium chloride (Quab 151 from Degussa).

### EXAMPLE 6

### Reaction product of N,N′-Bis(3-(11-perfluorobutyl, 10-undecylenamido)propyl)ethylenediamine and 3-chloro-2-hydroxypropyl-N, N,N-dimethyloctadecylammonium chloride

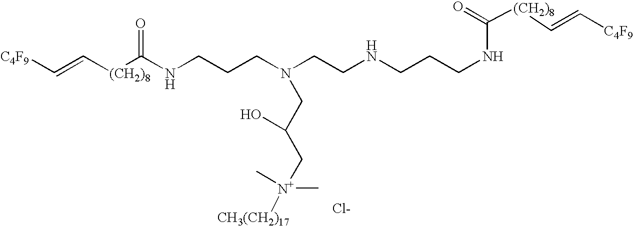

Following the procedure of Example 2, a product is synthesized using 3-chloro-2-hydroxypropyl-N, N,N-dimethyloctadecylammonium chloride (Quab 426 from Degussa, 38% actives) instead of glycidyltrimethylammonium chloride (Quab 151 from Degussa).

### EXAMPLE 7

### Reaction Product of Diethylenetriamine-N,N″-bis-11-perfluoroalkyl-10-undecylenylamide-N′-succinamide and Polyethyleneimine

### 7A: Diethylenetriamine-N,N″-bis-10-undecylenylamide

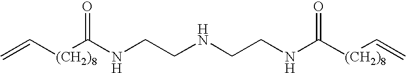

Diethylenetriamine (101 g, 969.0 mmol, 99% assay, Aldrich) and undecylenic acid (364.0 g, 1938 mmol, Acros, 98% assay) are placed into a round-bottomed flask equipped with a stirrer, nitrogen inlet and a thermoregulator. This mixture is heated with stirring. The reaction mixture is then stirred for 5 hours at 190 C. Consumption of Undecylenic acid is monitored by gas chromatography. Typically, this product is not isolated but used directly in the next step.

### 7B: Diethylenetriamine-N,N″-bis-11-perfluoroalkyl-10-undecylenylamide-N′-succinamide

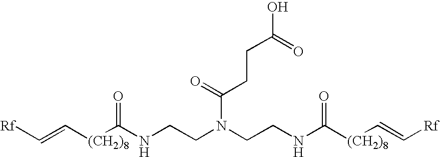

The compound from Example 7A (331.4 g, 760 mmol) is placed into a round-bottomed flask equipped with a stirrer, nitrogen inlet, thermoregulator and heated to 100 C. When the temperature reaches 90 C, succinic anhydride (82.4 g, 798 mmol, Aldrich) is added to the flask. The reaction mixture is maintained at 100 C for 5 hours with stirring. Consumption of succinic anhydride is monitored by FTIR spectroscopy. At the end of the five hour hold, 220 g of 2-propanol and 154.2 g of deionized water are added to the flask. Sodium hydroxide (91.2 g, 1140 mmol, 50% assay) is added to the mixture. The temperature is then reheated to 80 C, at which time, perfluoroalkyl iodide (ZONYL TELA-N, 899.5 g, 1498 mmol) and sodium hydroxymethylsulfinate (5.9 g, 38 mmol) are added. A temperature increase from 81 C to 88 C is observed. When the rise in temperature subsides, the reaction mixture is maintained at 80 C for 5 hours with stirring. After five hours the mixture is cooled to 70 C and sample for gas chromatographic analysis. Conversion of R_{F}-iodide, as determined by gas chromatography, is >99%. Sodium hydroxide (165 g, 2056 mmol, 50% assay) is added to the mixture. The reaction mixture is maintained at 70° C. for 5 hours with stirring. Completion of the dehydrohalogenation reaction is determined by chloride titration with silver nitrate, after which the mixture is acidified with hydrochloric acid until the pH is 1.0. Diethylketone (239.1 g) and 530 g of deionized water are added to wash any salt from the mixture. The top layer is removed and the washing process repeated once. The sample is then oven dried at 50° C. under vacuum to yield a light brown solid.

### 7C: Reaction Product of Diethylenetriamine-N,N″-bis-11-perfluoroalkyl-10-undecylenylamide-N′-succinamide and Polyethyleneimine

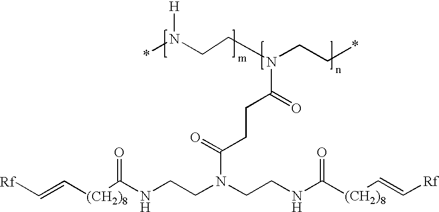

Polyethyleneimine, (3.0 g, 5 mmol, Mn=600 Daltons, Aldrich) and 6.8 g of the compound from Example 7B are placed into a round-bottomed flask equipped with a stirrer, nitrogen inlet and a thermoregulator. The temperature of the reaction mixture is increased to 150 C. The reaction mixture is stirred for four hours at 115° C. Some distillate is collected and the reaction is monitored by FTIR spectroscopy. 31.5 g of deionized water is added to the sample to become a dark brown homogeneous mixture. Some of this product (12.3 g) is isolated and used directly in Instant Example 29.

### EXAMPLE 8

### Reaction Product of Diethylenetriamine-N,N″-bis-11-perfluorobutyl-10-undecylenylamide-N′-succinamide/Polyethyleneimine Adduct and Glycidyltrimethylammonium chloride

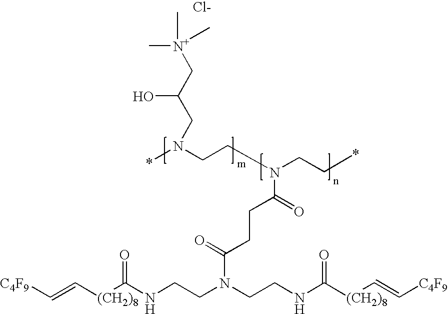

Following the procedure of Example 7B, the desired product is synthesized using Perfluorobutyl iodide (99%) instead of Zonyl TEL AN. This intermediate is further reacted following Example 29 to yield the desired product.

### EXAMPLE 9

### Reaction Product of Diethylenetriamine-N,N″-bis-11-perfluoroalkyl-10-undecylenylamide-N′-succinamide/Polyethyleneimine Adduct and 3-Chloro-2-hydroxypropyl-N, N,N-dimethyloctadecylammonium chloride

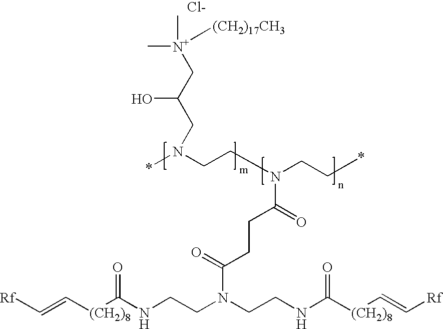

Following the procedure of Example 29, a product is synthesized using 3-chloro-2-hydroxypropyl-N, N,N-dimethyloctadecylammonium chloride (Quab 426 from Degussa, 38% actives) instead of glycidyltrimethylammonium chloride (Quab 151 from Degussa).

### EXAMPLE 10

### Reaction Product of Diethylenetriamine-N,N″-bis-11-perfluoroalkyl-10-undecylenylamide-N′-succinamide/Polyethyleneimine Adduct and 3-Chloro-2-hydroxypropyl-N, N,N-dimethyldodecylammonium chloride

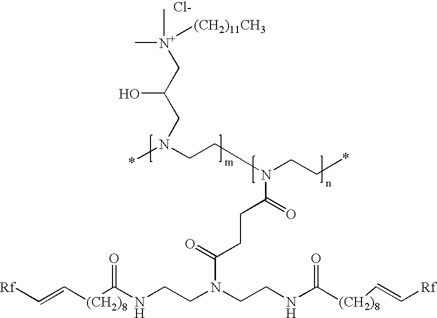

Following the procedure of Example 29, a product is synthesized using 3-chloro-2-hydroxypropyl-N, N,N-dimethyldodecylammonium chloride (Quab 342 from Degussa, 38% actives) instead of glycidyltrimethylammonium chloride (Quab 151 from Degussa).

### EXAMPLE 11

### Reaction Product of Diethylenetriamine-N,N″-bis-11-perfluorobutyl-10-undecylenylamide-N′-succinamide/Polyethyleneimine Adduct and 3-Chloro-2-hydroxypropyl-N, N,N-dimethyldodecylammonium chloride

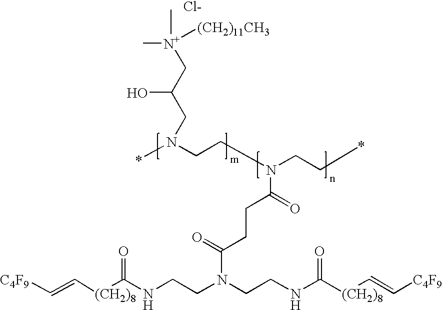

Following the procedure of Example 8, a product is synthesized using 3-chloro-2-hydroxypropyl-N, N,N-dimethyldodecylammonium chloride (Quab 342 from Degussa, 38% actives) instead of glycidyltrimethylammonium chloride (Quab 151 from Degussa).

### EXAMPLE 12

### Reaction Product of Diethylenetriamine-N,N″-bis-11-perfluorobutyl-10-undecylenylamide-N′-succinamide/Polyethyleneimine Adduct and 3-Chloro-2-hydroxypropyl-N, N,N-dimethyloctadecylammonium chloride

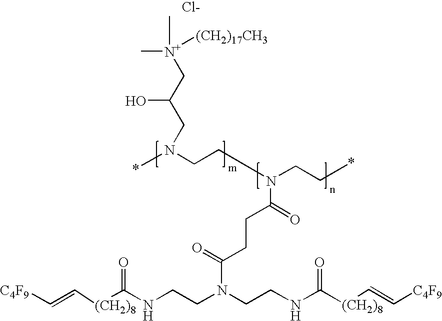

Following the procedure of Example 8, a product is synthesized using 3-chloro-2-hydroxypropyl-N, N,N-dimethyloctadecylammonium chloride (Quab 426 from Degussa, 38% actives) instead of glycidyltrimethylammonium chloride (Quab 151 from Degussa).

### EXAMPLE 13

### Reaction Product of Perfluoroalkyl-10-undecylenylamides from polyethyleneimine (PEI) and Glycidyltrimethylammonium chloride

### 13A: Undecylenylamides from polyethyleneimine (PEI)

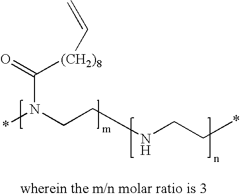

Polyethyleneimine, (40 g, 66.6 mmol, Mn=600, Aldrich) and undecylenic acid (36.8 g, 199.7 mmol, Acros, 98% assay) are placed into a round-bottomed flask equipped with a stirrer, nitrogen inlet and a thermoregulator. This mixture is heated with stirring. The reaction mixture is stirred for 5 hours at 190 C. Consumption of undecylenic acid is monitored by gas chromatography. Typically, this product is not isolated, but used directly in the next step.

### 13B: Perfluoroalkyl-10-undecylenylamides from polyethyleneimine (PEI)

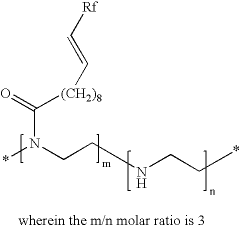

The compound from Example 13A (30.0 g, 27.2 mmol) is placed into a round-bottomed flask equipped with a stirrer, nitrogen inlet and a thermoregulator. To this round-bottomed flask is added 11 g of hexylene glycol and 12.5 g of deionized water. Sodium hydroxide (2.2 g, 27.2 mmol, 50% assay) is added to the mixture. The reaction mixture is heated to 78 C at which time Zonyl TELA-N (44.3 g, 73.5 mmol) is added to the reaction mixture along with sodium hydroxymethylsulfinate (0.21 g, 1.4 mmol) and 2,2′-azobisisobutyronitrile (0.13 g, 0.69 mmol). The reaction mixture is stirred under nitrogen at 80 C for five hours and sampled for completion. Conversion of R_{F}-iodide, as determined by gas chromatography, is >99%. Sodium hydroxide (8.8 g, 110 mmol, 50% assay) is added to the mixture. The reaction mixture temperature is maintained at 70 C for 5 hours with stirring. Completion of the dehydrohalogenation reaction is determined by chloride titration with silver nitrate.

### 13C: Reaction Product of Perfluoroalkyl-10-undecylenylamides from polyethyleneimine (PEI) and Glycidyltrimethylammonium chloride

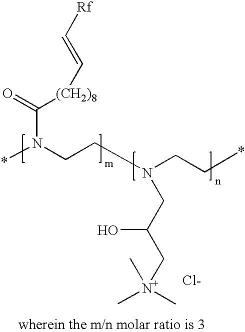

The compound from Example 13B (51.7 g, 136 mmol) is placed into a round-bottomed flask equipped with a stirrer, nitrogen inlet, thermoregulator and heated. When the temperature reaches 60 C, sodium hydroxide (2.2 g, 27.5 mmol, 50% assay), 3.3 g of hexylene glycol and 8.7 g of deionized water are added to the flask. Glycidyltrimethylammonium chloride (13.75 g, Quab 151, Degussa) is added and the reaction mixture temperature is maintained at 60 C for 5 hours with stirring. After five hours, a semi viscous yellow mixture is obtained. Deionized water (99.6 g) is added to the flask along with 12.9 g of hydrochloric acid. An aliquot is then oven dried at 50° C. under vacuum to yield a concentration of 27.8% solids.

### EXAMPLE 14

### Reaction Product of Perfluorobutyl-10-undecylenylamides from Polyethyleneimine (PEI) and Glycidyltrimethylammonium chloride

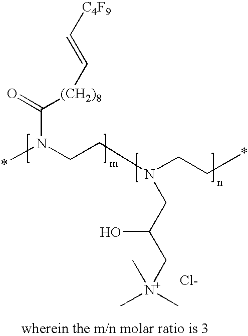

Following the procedure of Example 13B, the desired product is synthesized using Perfluorobutyl iodide (99%) instead of Zonyl TEL AN. This intermediate is further reacted following example 13 C to yield the desired product.

### EXAMPLE 15

### Reaction Product of Perfluoroalkyl-10-undecylenylamides from polyethyleneimine (PEI) and 3-Chloro-2-hydroxypropyl-N, N,N-dimethyloctadecylammonium Chloride

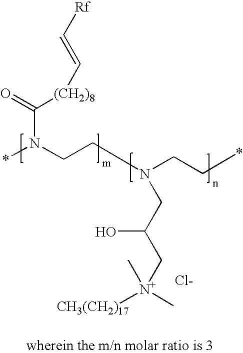

Following the procedure of Example 13C, a product is synthesized using 3-chloro-2-hydroxypropyl-N, N,N-dimethyloctadecylammonium chloride (Quab 426 from Degussa, 38% actives) instead of glycidyltrimethylammonium chloride (Quab 151 from Degussa).

### EXAMPLE 16

### Reaction Product of Perfluoroalkyl-10-undecylenylamides from Polyethyleneimine (PEI) and 3-Chloro-2-hydroxypropyl-N, N,N-dimethyldodecylammonium Chloride

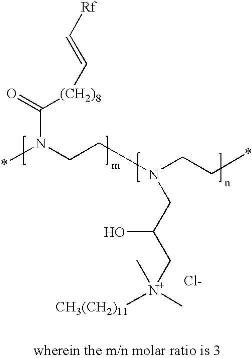

Following the procedure of Example 13C, a product is synthesized using 3-chloro-2-hydroxypropyl-N, N,N-dimethyldodecylammonium chloride (Quab 342 from Degussa, 38% actives) instead of glycidyltrimethylammonium chloride (Quab 151 from Degussa).

### EXAMPLE 17

### Reaction Product of Perfluorobutyl-10-undecylenylamides from polyethyleneimine (PEI) and 3-Chloro-2-hydroxypropyl-N, N,N-dimethyldodecylammonium Chloride

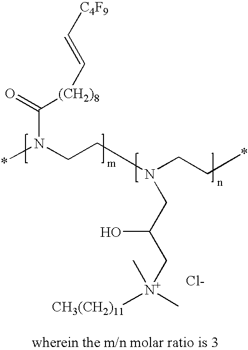

Following the procedure of Example 14, a product is synthesized using 3-chloro-2-hydroxypropyl-N, N,N-dimethyldodecylammonium chloride (Quab 342 from Degussa, 38% actives) instead of glycidyltrimethylammonium chloride (Quab 151 from Degussa).

### EXAMPLE 18

### Reaction Product of Perfluorobutyl-10-undecylenylamides from Polyethyleneimine (PEI) and 3-Chloro-2-hydroxypropyl-N, N,N-dimethyloctadecylammonium Chloride

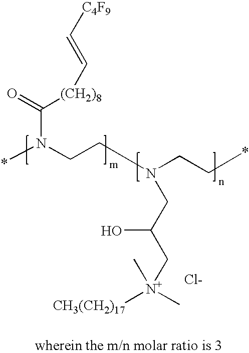

Following the procedure of Example 14, a product is synthesized using 3-chloro-2-hydroxypropyl-N, N,N-dimethyloctadecylammonium chloride (Quab 426 from Degussa, 38% actives) instead of glycidyltrimethylammonium chloride (Quab 151 from Degussa).

### EXAMPLE 19

### Reaction Product of Perfluoroalkyl adduct of PEI/allyl glycidyl ether product and Glycidyltrimethylammonium chloride

### 19A: Reaction product between PEI and ally glycidyl ether

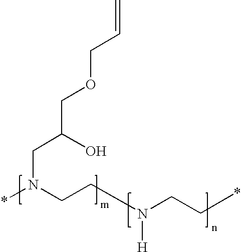

Polyethyleneimine (15.0 g, 25 mmol, Mn=600, Aldrich) and 4.3 g deionized water are placed into a round-bottomed flask equipped with a stirrer, nitrogen inlet and a thermoregulator. The temperature of the reaction mixture is increased to 65 C and allyl glycidyl ether, (8.5 g, 75 mmol, Aldrich) are added over 15 minutes. The reaction mixture is stirred for two hours at 65 C, after which time conversion of allyl glycidyl ether is complete, as monitored by gas chromatography. This product is not isolated, but used directly in the next step.

### 19B: Perfluoroalkyl-iodo adduct of PEI/allyl glycidyl ether product

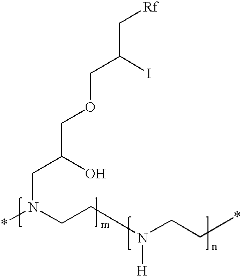

To this round-bottomed flask, 12.5 g of hexylene glycol and 10.1 g of deionized water are added to the mixture. The reaction mixture is heated to 78 C. ZONYL TELA-N (40.6 g, 67.5 mmol) is added to the reaction mixture along with sodium hydroxymethylsulfinate (0.2 g, 1.3 mmol). The reaction mixture is stirred under nitrogen at 80 C for five hours and sample for completion. Conversion of R_{F}-iodide, as determined by gas chromatography, is >99%.

### 19C: Reaction Product of Perfluoroalkyl adduct of PEI/allyl glycidyl ether product and Glycidyltrimethylammonium chloride

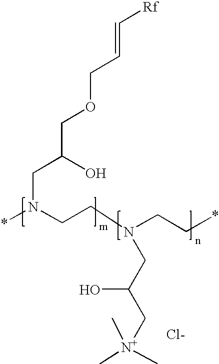

Sodium hydroxide (8.2 g, 103 mmol, 50% assay) is added to the mixture and the reaction mixture temperature is maintained at 70 C for 5 hours with stirring. Completion of the dehydrohalogenation reaction is determined by chloride titration with silver nitrate. After the temperature is adjusted to 60 C, glycidyltrimethylammonium chloride (25.3 g, Quab 151, Degussa) is added. The reaction mixture is maintained at 60 C for 5 hours with stirring. After five hours, a semi viscous yellow mixture is obtained. Deionized water (90 g) is added to the flask along with 14.6 g of concentrated hydrochloric acid. An aliquot is then oven dried at 50 C under vacuum to yield a concentration of 40.2% solids.

### EXAMPLE 20

### Reaction Product of Perfluorobutyl adduct of PEI/allyl glycidyl ether product and Glycidyltrimethylammonium chloride

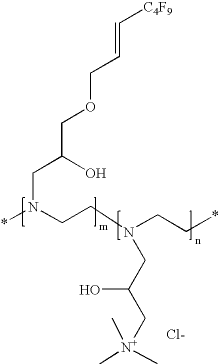

Following the procedure of Example 19, the desired product is synthesized using perfluorobutyl iodide (99%) instead of Zonyl TEL AN. This intermediate is further reacted following Example 13C to yield the desired product.

### EXAMPLE 21

### Reaction Product of Perfluoroalkyl adduct of PEI/allyl glycidyl ether product and 3-Chloro-2-hydroxypropyl-N, N,N-dimethyloctadecylammonium chloride

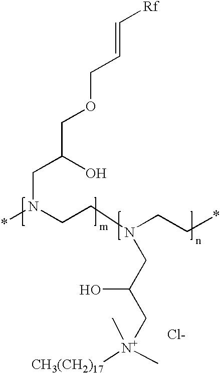

Following the procedure of Example 19, a product is synthesized using 3-chloro-2-hydroxypropyl-N, N,N-dimethyloctadecylammonium chloride (Quab 426 from Degussa, 38% actives) instead of glycidyltrimethylammonium chloride (Quab 151 from Degussa).

### EXAMPLE 22

### Reaction Product of Perfluoroalkyl adduct of PEI/allyl glycidyl ether product and 3-Chloro-2-hydroxypropyl-N, N,N-dimethyldodecylammonium chloride

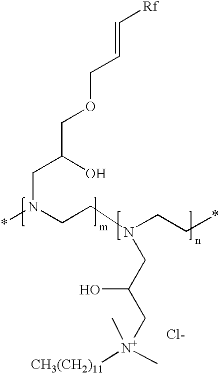

Following the procedure of Example 19, a product is synthesized using 3-chloro-2-hydroxypropyl-N, N,N-dimethyldodecylammonium chloride (Quab 342 from Degussa, 38% actives) instead of glycidyltrimethylammonium chloride (Quab 151 from Degussa).

### EXAMPLE 23

### Reaction Product of Perfluorobutyl adduct of PEI/allyl glycidyl ether product and 3-Chloro-2-hydroxypropyl-N, N,N-dimethyldodecylammonium chloride

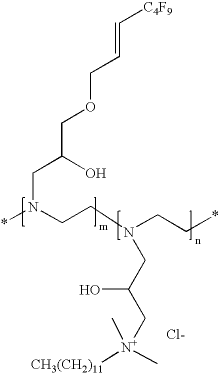

Following the procedure of Example 20, a product is synthesized using 3-chloro-2-hydroxypropyl-N, N,N-dimethyldodecylammonium chloride (Quab 342 from Degussa, 38% actives) instead of glycidyltrimethylammonium chloride (Quab 151 from Degussa).

### EXAMPLE 24

### Reaction Product of Perfluorobutyl adduct of PEI/allyl glycidyl ether product and 3-Chloro-2-hydroxypropyl-N, N,N-dimethyldodecylammonium chloride

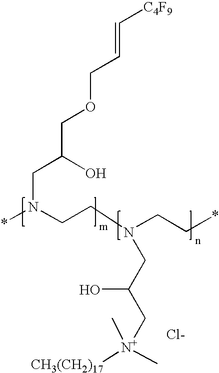

Following the procedure of Example 20, a product is synthesized using 3-chloro-2-hydroxypropyl-N, N,N-dimethyloctadecylammonium chloride (Quab 426 from Degussa, 38% actives) instead of glycidyltrimethylammonium chloride (Quab 151 from Degussa).

### EXAMPLE 25

### Treatment of Glass Slides with Instant Perfluoroalkyl Compound Solution

Clean glass slides (50 mm×75 mm) are submerged in a 0.1% solution of perfluoroalkyl compound in 100 mL deionized water in a 150 mL beaker for 1 min. A control slide is treated in water alone. The slides are then rinsed with flowing deionized water for 5 seconds on each side and allowed to drain dry vertically. After drying completely, the advancing contact angle of the treated slide surface is measured using a Kruss Drop Shape Analyzer with video imaging software. Both water and olive oil are used as test liquids.

| Treatment Solution | Contact Angle (water) | Contact Angle (olive oil) |
|---|---|---|
| Control (water) | 18.2 | 31.1 |
| Instant Example 1C | 73.4 | 51.8 |
| Instant Example 29 | 60.6 | 45 |
| Instant Example 13C | 61.3 | 40.3 |
| Instant Example 19C | 76.9 | 49.7 |
| Lodyne 5100 | 55.8 | 44.8 |
| Lodyne 2000 | 48.3 | 44.5 |

Lodyne 2000 is water based anionic fluorochemical surfactant based on the ammonium salt of a perfluoroalkyl substituted amino acid carboxylate which is disclosed in Ciba trade literature dated, November 2004 edition, from Ciba Specialty Chemicals.
Lodyne 5100 is an anionic surfactant that is based on high molecular weight perfluoroalkyl substituted polyaminoacid and is disclosed in US2006/0097217 and US 2003/0141081.

Contact angles significantly higher than the control slide for both water and oil indicate a low energy fluorinated surface which is advantageous in a cleaning composition or formulation.

### EXAMPLE 26

### Treatment of Ceramic Tiles with Instant Fluoropolymer Solution

Clean white ceramic tiles (10 cm×10 cm) are treated by wiping with a folded paper towel that is dampened with 2 mL of a 0.1% solution of perfluoroalkyl compound in deionized water for 30 seconds. A control tile is wiped with water alone. The tiles are then rinsed with flowing deionized water for 15 seconds and allowed to drain dry vertically. After drying completely, the advancing contact angle of the treated tile surface is measured using a Kruss Drop Shape Analyzer with video imaging software. Both water and olive oil are used as test liquids.

| Treatment Solution | Contact Angle (water) | Contact Angle (olive oil) |
|---|---|---|
| Control (water) | 14.1 | 29 |
| Instant Example 1C | 77.8 | 53.3 |
| Instant Example 29 | 77.7 | 54.1 |
| Instant Example 13C | 73.7 | 50 |
| Instant Example 19C | 88.8 | 58.6 |
| Lodyne 5100 | 64.3 | 25 |
| Lodyne 2000 | 64.7 | 54.1 |

Lodyne 2000 is water based anionic fluorochemical surfactant based on the ammonium salt of a perfluoroalkyl substituted amino acid carboxylate which is disclosed in Ciba trade literature dated, November 2004 edition, from Ciba Specialty Chemicals.
Lodyne 5100 is an anionic surfactant that is based on high molecular weight perfluoroalkyl substituted polyaminoacid and is disclosed in US2006/0097217 and US 2003/0141081.

Contact angles significantly higher than the control slide for both water and oil indicate a low energy fluorinated surface which is advantageous in a cleaning composition or formulation.

### EXAMPLE 27

### Treatment of Ceramic Tiles with Instant Perfluoroalkyl Compound in Commercial Cleaner

Clean white ceramic tiles (10 cm×10 cm) are treated by wiping with a folded paper towel that is dampened with 2 mL of a 0.1% solution of perfluoroaklyl compound in a commercial all-purpose hard surface cleaning solution (Lysol “Direct”) for 30 seconds. Control tiles are wiped with either water or cleaning solution alone. The tiles are then rinsed with flowing deionized water for 15 seconds and allowed to drain dry vertically. After drying completely, the advancing contact angle of the treated tile surface is measured using a Kruss Drop Shape Analyzer with video imaging software. Both water and olive oil were used as test liquids.

| Treatment Solution | Contact Angle (water) | Contact Angle (olive oil) |
|---|---|---|
| Control (water) | 22.6 | 26.5 |
| Control (cleaner) | 29.6 | 23.6 |
| Instant Example 1C | 53.8 | 29.1 |
| Instant Example 29 | 76.2 | 32.5 |
| Instant Example 13C | 81.8 | 39.3 |
| Instant Example 19C | 93.9 | 48.3 |

The elevated contact angles found for the tiles treated with the instant perfluoroalkyl compound solution indicate that the surface is modified even in the presence of a cleaning solution containing cationic surfactant.

### EXAMPLE 28

### Soil Removal Test after Surface Treatment with Instant Perfluoroalkyl Compound

Clean white ceramic tiles (20 cm×20 cm) are treated on one half by wiping with a folded paper towel that is dampened with 2 mL of a 0.1% solution of perfluoroalkyl compound in deionized water for 30 seconds. The “control” half of the tile is wiped with water alone. The tiles are then rinsed with flowing deionized water for 15 seconds and allowed to drain dry vertically. The treated tiles are then coated with an oily particulate soil [composed of 39.55 g corn oil, 7.91 g kaolin, 2.5 g oleic acid and 0.04 g Oil Blue N] using a paintbrush to form a thin film over the entire tile. The soiled tiles are allowed to stand at room temperature for 2 hours, then are baked at 85 C for 18-24 hours. The blue soil turns to a pink/violet color after heating.

The tiles are then cleaned using a Gardner Washability Tester Model D10V, using two side-by-side water moistened sponges treated with equivalent amounts of commercial hard surface cleaning formulation. The cleaning is typically carried out for 10 strokes with the Washability Tester, or until one or both sides is substantially free of soil. Results for cleaning are shown below, with the degree of cleaning represented as “% of soil removal”.

| | % Soil Removal | |
|---|---|---|
| Treatment Solution | (Treated) | % Soil Removal (Control) |
| Instant Example 1C | 90 | 30 |
| Instant Example 29 | 85 | 60 |
| Instant Example 19C | 95 | 20 |
| Lodyne 2000 | 80 | 65 |

Lodyne 2000 is water based anionic fluorochemical surfactant based on the ammonium salt of a perfluoroalkyl substituted amino acid carboxylate which is disclosed in Ciba trade literature dated, November 2004 edition, from Ciba Specialty Chemicals.

As shown, the degree of soil removal is substantially higher on the tile treated with the instant perfluoroalkyl compound versus the untreated side.

### EXAMPLE 29

### Reaction Product of Diethylenetriamine-N,N″-bis-11-perfluoroalkyl-10-undecylenylamide-N′-succinamide/Polyethyleneimine Adduct and Glycidyltrimethylammonium chloride

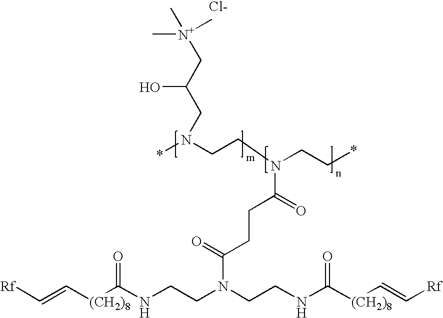

The reaction product Instant Example 7C (12.3 g) and glycidyltrimethylammonium chloride (1.7 g, Quab 151, Degussa) are added to a reaction flask and stirred at 60 C for 3 hours. After the completion of the reaction as judged by FT-IR, 23.6 g of deionized water is added to the mixture to yield a brown mixture of 14.5% solids.

### EXAMPLE 30

### A Glass and Surface Cleaner Formulation with Antifog Properties

A glass and surface cleaner formulation is prepared according to U.S. Pat. No. 4,606,842. An effective amount of one or more of the compounds of Instant Formulae (I)-(IX) is added. The cleaning properties of the formulation are greatly improved.

### EXAMPLE 31

### A Glass and Surface Cleaner Formulation

A glass and surface cleaner formulation is prepared according to U.S. Pat. No. 5,750,482. An effective amount of one or more of the compounds of Instant Formulae (I)-(IX) is added. The cleaning properties of the formulation are greatly improved.

### EXAMPLE 32

### An Antistatic Plastic Cleaner Formulation

An antistatic plastic cleaner formulation is prepared according to U.S. Pat. No. 4,511,489. An effective amount of one or more of the compounds of Instant Formulae (I)-(IX) is added. The cleaning properties of the formulation are greatly improved.

### EXAMPLE 33

### A Floor Cleaner with Degreaser Formulation

A floor cleaner with degreaser formulation is prepared according to U.S. Pat. No. 6,342,473. An effective amount of one or more of the compounds of Instant Formulae (I)-(IX) is added. The cleaning properties of the formulation are greatly improved.

### EXAMPLE 34

### A Disinfecting Kitchen and Bathroom Cleaner Formulation

A disinfecting kitchen and bathroom cleaner formulation is prepared according to U.S. Pat. No. 6,306,810. An effective amount of one or more of the compounds of Instant Formulae (I)-(IX) is added. The cleaning properties of the formulation are greatly improved.

### EXAMPLE 35

### A Metal De-Oiling Liquid Concentrate Cleaner Formulation

A metal de-oiling liquid concentrate cleaner formulation is prepared according to a Formulation Guide from PQ Corporation. An effective amount of one or more of the compounds of Instant Formulae (I)-(IX) is added.

| Ingredient | Amount (wt %) |
|---|---|
| Sodium silicate (37.5% active) | 12.00 |
| Tetrasodium EDTA (37% active) | 16.00 |
| Sodium xylene sulfonate (40% active) | 20.00 |
| C9-C11 linear alcohol ethoxylated, | 3.00 |
| 6 moles of EO | |
| C9-C11 linear alcohol ethoxylated, | 7.00 |
| 2.5 moles of EO | |
| Nonionic fluorosurfactant | 0.02 |
| Instant Compound of | 1.00 |
| Formula (I)-(IX) | |
| Water | q.s. 100% |

The cleaning properties of the formulation are greatly improved.

### EXAMPLE 36

### A Concrete Destainer Cleaner Formulation

A concrete destainer cleaner formulation is prepared according to a Formulation Guide from PQ Corporation. An effective amount of one or more of the compounds of Instant Formulae (I)-(IX) is added.

| Ingredient | Amount (wt %) |
|---|---|
| Sodium tripolyphosphate | 1.25 |
| Sodium metasilicate pentahydrate | 0.62 |
| Sodium sulfate | 0.40 |
| Epsom salt | 0.10 |
| Octylphenoxy polyethoxyethanol, | 0.10 |
| 9-10 moles of EO | |
| Anionic fluorosurfactant | 0.02 |
| Sodium perborate monohydrate | 1.90 |
| Instant Compound of | 0.50 |
| Formula (I)-(IX) | |
| Water | q.s. 100% |

The cleaning properties of the formulation are greatly improved.

### EXAMPLE 37

### A Toilet Bowl Cleaner Formulation

A toilet bowl cleaner formulation is prepared according to U.S. Pat. No. 6,255,267. An effective amount of one or more of the compounds of Instant Formulae (I)-(IX) is added. The cleaning properties of the formulation are greatly improved.

### EXAMPLE 38

### A Drain Cleaner Formulation

A drain cleaner formulation is prepared according to U.S. Pat. No. 5,624,891. An effective amount of one or more of the compounds of Instant Formulae (I)-(IX) is added. The cleaning properties of the formulation are greatly improved.

### EXAMPLE 39

### A Drain Cleaner Formulation

A drain cleaner formulation is prepared according to U.S. Pat. No. 4,587,032. An effective amount of one or more of the compounds of Instant Formulae (I)-(IX) is added. The cleaning properties of the formulation are greatly improved.

What is claimed is:

1. A hard surface cleaning and protectant composition comprising:
(i) 0.001-25 wt-%, based on the total weight of said composition, of at least one compound selected from the group consisting of
(Q)_{z}-A-NHC(═O)—(W—R_{F})ₓ (I),
A-(Q₁-A-NHC(═O)—(W—R_{F})ₓ)_{y}—NHC(═O)—(W—R_{F})ₓ (II),
a substituted polyethyleneimine polymer of formula (VIII) 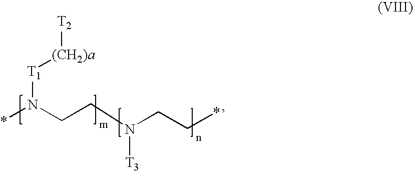
and
a substituted polyvinylamine polymer of formula (IX) 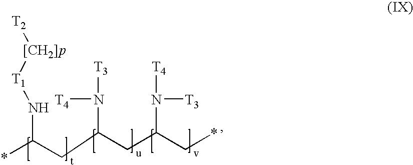
wherein
A is the hydrocarbon residue of an aliphatic, cycloaliphatic or aromatic mono-, di- or polyamine of 60 to 2000 molecular weight, which is optionally substituted by hydroxy- and/or carboxyl groups and whose carbon chain is optionally interrupted by one or more ether, amide or amino groups, which amino groups are optionally substituted by substituents of the formula -Q- or -Q₁-,
wherein
Q is a monovalent radical connected to a nitrogen atom of (A) and is derived from an acid, acid chloride or lower alkyl ester, an anhydride, a halogenated carboxylic acid, an alkyl or alkenyl halide, an oxirane compound or chloroacetamide, and which is optionally substituted by one or more hydroxy-, tert. amino or carboxyl groups, or is optionally interrupted by one or more ether or thioether linkages, and optionally contains one or more unsaturated groups and can be substituted by an R_{F} group, or is —P(═O)(OH)₂; —SO₃H; or —C(═O)—NH₂;
Q₁ is a difunctional linking group attached to the nitrogen atoms of two A groups and is derived from a diacid, diacid chloride or -lower alkyl ester; a dianhydride, a diisocyanate, epichlorohydrin, or is —C(═O)—, or is a trifunctional group derived from cyanuric acid;
each R_{F} is independently a monovalent perfluorinated alkyl or alkenyl, linear or branched organic radical having four to twenty fully fluorinated carbon atoms, or mixtures of different alkyl or alkenyl chain lengths;
W is —(CH₂)ₚCH═CH— in which p is 1 to 20, or is a C₆-C₁₀cycloaliphatic hydrocarbyl group connecting an R_{F} group to an amide carbonyl;
z is zero to 50;
y is zero to 50; and
x is 1 to 10;
T1 is a direct bond or —C(═O)—;
T2 is —CHI—CH₂—R_{F}; —CH═CH—R_{F}; —CH(OH)CH₂—O—CH₂CHI—CH₂—R_{F}; or —CH(OH)CH₂—O—CH₂CH═CH—R_{F} or mixtures thereof;
a is one to twenty;
p is one to twenty;
T3 and T4 are independently hydrogen; a C₁-C₁₈alkyl radical; a C₁-C₁₈monohydroxyalkyl radical; a C₁-C₁₈monohydroxyalkyl radical interrupted by one or more oxygen atoms; a C₁-C₁₈monohydroxyalkyl radical interrupted by one or more —N(H)—, —N(T5)-, or —N⁺(T5)(T6)(Y—)— groups; a C₁-C₁₈ monohydroxyalkyl radical interrupted by one or more oxygen atoms further interrupted by alkenyl; a C₂-C₁₈poly-hydroxyalkyl radical; an aryl radical; a benzyl radical; a (C₁-C₁₈)alkylamine radical; a (C₁-C₁₈)alkylamine radical protected with a (C₁-C₁₈)alkylcarbonyl, carbamyl or (C₁-C₁₈)-alkylsulfonyl radical; a (C₁-C₁₈)alkylcarbonyl radical; a cyano(C₁-C₁₈)alkyl radical; a carbamyl(C₁-C₁₈)alkyl radical; a C₁-C₁₈trifluoroalkyl radical; a C₁-C₁₈ aminosulfonylalkyl radical; a (C₁-C₁₈)alkylcarbonyl-(C₁-C₁₈)alkyl radical; a (C₁-C₁₈)alkylsulfinyl(C₁-C₁₈)alkyl radical; a (C₁-C₁₈)alkyl-sulfonyl(C₁-C₁₈)alkyl radical; a (C₁-C₁₈)alkyl-keto-(C₁-C₁₈)alkyl; an N—(C₁-C₁₈)alkyl-aminosulfonyl(C₁-C₁₈)alkyl radical or a N—(C₁-C₁₈)alkylaminosulfonyl(C₁-C₁₈)alkyl radical;
T5 and T6 are independently hydrogen; a C₁-C₁₈alkyl radical; a C₁-C₁₈monohydroxyalkyl radical; a C₁-C₁₈monohydroxyalkyl radical interrupted by one or more oxygen atoms; a C₁-C₁₈monohydroxyalkyl radical interrupted by one or more —N(H)— groups; a C₁-C₁₈monohydroxyalkyl radical interrupted by one or more oxygen atoms further interrupted by alkenyl; a C₂-C₁₈poly-hydroxyalkyl radical; an aryl radical; a benzyl radical; a (C₁-C₁₈)alkylamine radical; a (C₁-C₁₈)alkylamine radical protected with a (C₁-C₁₈)alkylcarbonyl, carbamyl or (C₁-C₁₈)-alkylsulfonyl radical; a (C₁-C₁₈)alkylcarbonyl radical; a cyano(C₁-C₁₈)alkyl radical; a carbamyl(C₁-C₁₈)alkyl radical; a C₁-C₁₈trifluoroalkyl radical; a C₁-C₁₈ aminosulfonylalkyl radical; a (C₁-C₁₈)alkylcarbonyl-(C₁-C₁₈)alkyl radical; a (C₁-C₁₈)alkylsulfinyl(C₁-C₁₈)alkyl radical; a (C₁-C₁₈)alkyl-sulfonyl(C₁-C₁₈)alkyl radical; a (C₁-C₁₈)alkyl-keto-(C₁-C₁₈)alkyl; an N—(C₁-C₁₈)alkyl-aminosulfonyl(C₁-C₁₈)alkyl radical or a N—(C₁-C₁₈)alkylaminosulfonyl(C₁-C₁₈)alkyl radical;
In formula (VIII),
m is 0.0001-99.9999 weight percent of the total polymer;
n is 0.0001-99.9999 weight percent of the total polymer;
In formula (IX),
t is 0.0001-99.9998 weight percent of the total polymer;
u is 0.0001-99.9998 weight percent of the total polymer;
v is 0.0001-99.9998 weight percent of the total polymer;
with the proviso that at least one T2, T3, T4, Q, Q1, or A contains at least one cationic group;
(ii) 0-80 wt-% based on the total weight of the composition, of at least one detergent and/or at least one soap and/or at least one salt of a saturated C₈-C₂₂ fatty acid and/or at least one unsaturated C₈-C₂₂ fatty acid;
(iii) 0-50 wt-% based on the total weight of the composition, of at least one alcohol;
(iv) 0-50 wt-% based on the total weight of the composition, of typical ingredients for cleaning composition;
(v) 0-50 wt-% based on the total weight of the composition, of at least one acid; and
(vi) tap water or deionised water ad 100 wt-%.

2. A composition according to claim 1 comprising:
(i) from about 0.01 to about 10 wt-%, based on the total weight of said composition, of at least one compound selected from the group consisting of
(Q)_{z}-A-NHC(═O)—(W—R_{F})ₓ (I),
A-(Q₁-A-NHC(═O)—(W—R_{F})ₓ)_{y}—NHC(═O)—(W—R_{F})ₓ (II),
a substituted polyethyleneimine polymer of formula (VIII)
and 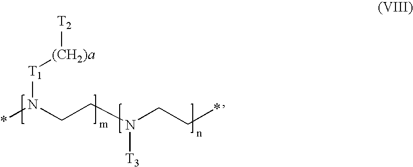
a substituted polyvinylamine polymer of formula (IX) 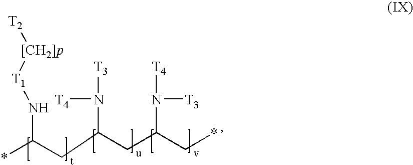
wherein
A is the hydrocarbon residue of an aliphatic, cycloaliphatic or aromatic mono-, di- or polyamine of 60 to 2000 molecular weight, which is optionally substituted by hydroxy- and/or carboxyl groups and whose carbon chain is optionally interrupted by one or more ether, amide or amino groups, which amino groups are optionally substituted by substituents of the formula -Q- or -Q₁-,
wherein
Q is a monovalent radical connected to a nitrogen atom of (A) and is derived from an acid, acid chloride or lower alkyl ester, an anhydride, a halogenated carboxylic acid, an alkyl or alkenyl halide, an oxirane compound or chloroacetamide, and which is optionally substituted by one or more hydroxy-, tert. amino or carboxyl groups, or is optionally interrupted by one or more ether or thioether linkages, and optionally contains one or more unsaturated groups and can be substituted by an R_{F} group, or is —P(═O)(OH)₂; —SO₃H; or —C(═O)—NH₂;
Q₁ is a difunctional linking group attached to the nitrogen atoms of two A groups and is derived from a diacid, diacid chloride or -lower alkyl ester; a dianhydride, a diisocyanate, epichlorohydrin, or is —C(═O)—, or is a trifunctional group derived from cyanuric acid;
each R_{F} is independently a monovalent perfluorinated alkyl or alkenyl, linear or branched organic radical having four to twenty fully fluorinated carbon atoms, or mixtures of different alkyl or alkenyl chain lengths;
W is —(CH₂)ₚCH═CH— in which p is 1 to 20, or is a C₆-C₁₀cycloaliphatic hydrocarbyl group connecting an R_{F} group to an amide carbonyl;
z is zero to 50;
y is zero to 50; and
x is 1 to 10;
T1 is a direct bond or —C(═O)—;
T2 is —CHI—CH₂—R_{F}; —CH═CH—R_{F}; —CH(OH)CH₂—O—CH₂CHI—CH₂—R_{F}; or —CH(OH)CH₂—O—CH₂CH═CH—R_{F} or mixtures thereof;
a is one to twenty;
p is one to twenty;
T3 and T4 are independently hydrogen; a C₁-C₁₈alkyl radical; a C₁-C₁₈monohydroxyalkyl radical; a C₁-C₁₈monohydroxyalkyl radical interrupted by one or more oxygen atoms; a C₁-C₁₈monohydroxyalkyl radical interrupted by one or more —N(H)—, —N(T5)-, or —N⁺(T5)(T6)(Y—)— groups; a C₁-C₁₈monohydroxyalkyl radical interrupted by one or more oxygen atoms further interrupted by alkenyl; a C₂-C₁₈poly-hydroxyalkyl radical; an aryl radical; a benzyl radical; a (C₁-C₁₈)alkylamine radical; a (C₁-C₁₈)alkylamine radical protected with a (C₁-C₁₈)alkylcarbonyl, carbamyl or (C₁-C₁₈)-alkylsulfonyl radical; a (C₁-C₁₈)alkylcarbonyl radical; a cyano(C₁-C₁₈)alkyl radical; a carbamyl(C₁-C₁₈)alkyl radical; a C₁-C₁₈trifluoroalkyl radical; a C₁-C₁₈ aminosulfonylalkyl radical; a (C₁-C₁₈)alkylcarbonyl-(C₁-C₁₈)alkyl radical; a (C₁-C₁₈)alkylsulfinyl(C₁-C₁₈)alkyl radical; a (C₁-C₁₈)alkyl-sulfonyl(C₁-C₁₈)alkyl radical; a (C₁-C₁₈)alkyl-keto-(C₁-C₁₈)alkyl; an N—(C₁-C₁₈)alkyl-aminosulfonyl(C₁-C₁₈)alkyl radical or a N—(C₁-C₁₈)alkylaminosulfonyl(C₁-C₁₈)alkyl radical;
T5 and T6 are independently hydrogen; a C₁-C₁₈alkyl radical; a C₁-C₁₈monohydroxyalkyl radical; a C₁-C₁₈monohydroxyalkyl radical interrupted by one or more oxygen atoms; a C₁-C₁₈monohydroxyalkyl radical interrupted by one or more —N(H)— groups; a C₁-C₁₈monohydroxyalkyl radical interrupted by one or more oxygen atoms further interrupted by alkenyl; a C₂-C₁₈poly-hydroxyalkyl radical; an aryl radical; a benzyl radical; a (C₁-C₁₈)alkylamine radical; a (C₁-C₁₈)alkylamine radical protected with a (C₁-C₁₈)alkylcarbonyl, carbamyl or (C₁-C₁₈)-alkylsulfonyl radical; a (C₁-C₁₈)alkylcarbonyl radical; a cyano(C₁-C₁₈)alkyl radical; a carbamyl(C₁-C₁₈)alkyl radical; a C₁-C₁₈trifluoroalkyl radical; a C₁-C₁₈ aminosulfonylalkyl radical; a (C₁-C₁₈)alkylcarbonyl-(C₁-C₁₈)alkyl radical; a (C₁-C₁₈)alkylsulfinyl(C₁-C₁₈)alkyl radical; a (C₁-C₁₈)alkyl-sulfonyl(C₁-C₁₈)alkyl radical; a (C₁-C₁₈)alkyl-keto-(C₁-C₁₈)alkyl; an N—(C₁-C₁₈)alkyl-aminosulfonyl(C₁-C₁₈)alkyl radical or a N—(C₁-C₁₈)alkylaminosulfonyl(C₁-C₁₈)alkyl radical;
In formula (VIII),
m is 0.0001-99.9999 weight percent of the total polymer;
n is 0.0001-99.9999 weight percent of the total polymer;
In formula (IX),
t is 0.0001-99.9998 weight percent of the total polymer;
u is 0.0001-99.9998 weight percent of the total polymer;
v is 0.0001-99.9998 weight percent of the total polymer;
with the proviso that at least one T2, T3, T4, Q, Q1, or A contains at least one cationic group;
(ii) from about 0.01 to about 25 wt-% based on the total weight of the composition, of at least one detergent and/or at least one soap and/or at least one salt of a saturated C₈-C₂₂ fatty acid and/or at least one unsaturated C₈-C₂₂ fatty acid;
(iii) from about 0.01 to about 45 wt-% based on the total weight of the composition, of at least one alcohol;
(iv) from about 0.01 to about 45 wt-% based on the total weight of the composition, of typical ingredients for cleaning composition;
(v) from about 0.01 to about 45 wt-% based on the total weight of the composition, of at least one acid; and
(vi) tap water or deionised water ad 100 wt-%.

3. A composition according to claim 2 comprising:
(i) from about 0.1 to about 5 wt-%, based on the total weight of said composition, of at least one compound selected from the group consisting of
(Q)_{z}-A-NHC(═O)—(W—R_{F})ₓ (I),
A-(Q₁-A-NHC(═O)—(W—R_{F})ₓ)_{y}—NHC(═O)—(W—R_{F})ₓ (II),
a substituted polyethyleneimine polymer of formula (VIII) 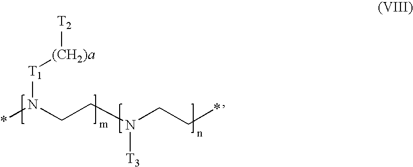
and
a substituted polyvinylamine polymer of formula (IX) 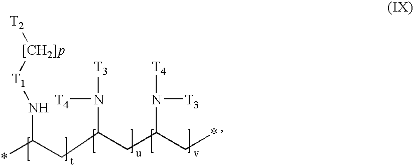
wherein
A is the hydrocarbon residue of an aliphatic, cycloaliphatic or aromatic mono-, di- or polyamine of 60 to 2000 molecular weight, which is optionally substituted by hydroxy- and/or carboxyl groups and whose carbon chain is optionally interrupted by one or more ether, amide or amino groups, which amino groups are optionally substituted by substituents of the formula -Q- or -Q₁-,
wherein
Q is a monovalent radical connected to a nitrogen atom of (A) and is derived from an acid, acid chloride or lower alkyl ester, an anhydride, a halogenated carboxylic acid, an alkyl or alkenyl halide, an oxirane compound or chloroacetamide, and which is optionally substituted by one or more hydroxy-, tert. amino or carboxyl groups, or is optionally interrupted by one or more ether or thioether linkages, and optionally contains one or more unsaturated groups and can be substituted by an R_{F} group, or is —P(═O)(OH)₂; —SO₃H; or —C(═O)—NH₂;
Q₁ is a difunctional linking group attached to the nitrogen atoms of two A groups and is derived from a diacid, diacid chloride or -lower alkyl ester; a dianhydride, a diisocyanate, epichlorohydrin, or is —C(═O)—, or is a trifunctional group derived from cyanuric acid;
each R_{F} is independently a monovalent perfluorinated alkyl or alkenyl, linear or branched organic radical having four to twenty fully fluorinated carbon atoms, or mixtures of different alkyl or alkenyl chain lengths;
W is —(CH₂)ₚCH═CH— in which p is 1 to 20, or is a C₆-C₁₀cycloaliphatic hydrocarbyl group connecting an R_{F} group to an amide carbonyl;
z is zero to 50;
y is zero to 50; and
x is 1 to 10;
T1 is a direct bond or —C(═O)—;
T2 is —CHI—CH₂—R_{F}; —CH═CH—R_{F}; —CH(OH)CH₂—O—CH₂CHI—CH₂—R_{F}; or —CH(OH)CH₂—O—CH₂CH═CH—R_{F} or mixtures thereof;
a is one to twenty;
p is one to twenty;
T3 and T4 are independently hydrogen; a C₁-C₁₈alkyl radical; a C₁-C₁₈monohydroxyalkyl radical; a C₁-C₁₈monohydroxyalkyl radical interrupted by one or more oxygen atoms; a C₁-C₁₈monohydroxyalkyl radical interrupted by one or more —N(H)—, —N(T5)-, or —N⁺(T5)(T6)(Y—)— groups; a C₁-C₁₈monohydroxyalkyl radical interrupted by one or more oxygen atoms further interrupted by alkenyl; a C₂-C₁₈poly-hydroxyalkyl radical; an aryl radical; a benzyl radical; a (C₁-C₁₈)alkylamine radical; a (C₁-C₁₈)alkylamine radical protected with a (C₁-C₁₈)alkylcarbonyl, carbamyl or (C₁-C₁₈)-alkylsulfonyl radical; a (C₁-C₁₈)alkylcarbonyl radical; a cyano(C₁-C₁₈)alkyl radical; a carbamyl(C₁-C₁₈)alkyl radical; a C₁-C₁₈trifluoroalkyl radical; a C₁-C₁₈ aminosulfonylalkyl radical; a (C₁-C₁₈)alkylcarbonyl-(C₁-C₁₈)alkyl radical; a (C₁-C₁₈)alkylsulfinyl(C₁-C₁₈)alkyl radical; a (C₁-C₁₈)alkyl-sulfonyl(C₁-C₁₈)alkyl radical; a (C₁-C₁₈)alkyl-keto-(C₁-C₁₈)alkyl; an N—(C₁-C₁₈)alkyl-aminosulfonyl(C₁-C₁₈)alkyl radical or a N—(C₁-C₁₈)alkylaminosulfonyl(C₁-C₁₈)alkyl radical;
T5 and T6 are independently hydrogen; a C₁-C₁₈alkyl radical; a C₁-C₁₈monohydroxyalkyl radical; a C₁-C₁₈monohydroxyalkyl radical interrupted by one or more oxygen atoms; a C₁-C₁₈monohydroxyalkyl radical interrupted by one or more —N(H)— groups; a C₁-C₁₈monohydroxyalkyl radical interrupted by one or more oxygen atoms further interrupted by alkenyl; a C₂-C₁₈poly-hydroxyalkyl radical; an aryl radical; a benzyl radical; a (C₁-C₁₈)alkylamine radical; a (C₁-C₁₈)alkylamine radical protected with a (C₁-C₁₈)alkylcarbonyl, carbamyl or (C₁-C₁₈)-alkylsulfonyl radical; a (C₁-C₁₈)alkylcarbonyl radical; a cyano(C₁-C₁₈)alkyl radical; a carbamyl(C₁-C₁₈)alkyl radical; a C₁-C₁₈trifluoroalkyl radical; a C₁-C₁₈ aminosulfonylalkyl radical; a (C₁-C₁₈)alkylcarbonyl-(C₁-C₁₈)alkyl radical; a (C₁-C₁₈)alkylsulfinyl(C₁-C₁₈)alkyl radical; a (C₁-C₁₈)alkyl-sulfonyl(C₁-C₁₈)alkyl radical; a (C₁-C₁₈)alkyl-keto-(C₁-C₁₈)alkyl; an N—(C₁-C₁₈)alkyl-aminosulfonyl(C₁-C₁₈)alkyl radical or a N—(C₁-C₁₈)alkylaminosulfonyl(C₁-C₁₈)alkyl radical;
In formula (VIII),
m is 0.0001-99.9999 weight percent of the total polymer;
n is 0.0001-99.9999 weight percent of the total polymer;
In formula (IX),
t is 0.0001-99.9998 weight percent of the total polymer;
u is 0.0001-99.9998 weight percent of the total polymer;
v is 0.0001-99.9998 weight percent of the total polymer;
with the proviso that at least one T2, T3, T4, Q, Q1, or A contains at least one cationic group;
(ii) from about 0.01 to about 25 wt-% based on the total weight of the composition, of at least one detergent and/or at least one soap and/or at least one salt of a saturated C₈-C₂₂ fatty acid and/or at least one unsaturated C₈-C₂₂ fatty acid;
(iii) from about 0.1 to about 10 wt-% based on the total weight of the composition, of at least one alcohol;
(iv) from about 0.1 to about 35 wt-% based on the total weight of the composition, of typical ingredients for cleaning composition;
(v) from about 0.1 to about 25 wt-% based on the total weight of the composition, of at least one acid; and
(vi) tap water or deionised water ad 100 wt-%.

4. A composition according to claim 1, wherein for formula (I) or (II) W is of the formula —(CH₂)ₚCH═CH— in which p is 5 to 12 and is derived from a terminally unsaturated alkenoic acid, or is derived from tetrahydrophthalic anhydride or (methyl)-norbornene anhydride; and R_{F} is saturated and contains 4-14 carbon atoms, is fully fluorinated and contains at least one terminal perfluoromethyl group.

5. A composition according to claim 1 wherein for formula (I) or (II), A is a hydrocarbon residue of an optionally substituted and/or interrupted monoamine.

6. A composition according to claim 5, wherein A is the hydrocarbon residue of glycine, p-aminosulfonic acid, taurine, 2-hydroxyethanolamine or is a tert. amino-substituted residue of the formula —(CH₂)ⱼ—N—(R₁)₂ wherein j is 2 to 6 and each R₁ is C₁-C₄alkyl.

7. A composition according to claim 1 wherein for formula (I) or (II), A is a hydrocarbon residue of an optionally substituted and/or interrupted diamine.

8. A composition according to claim 7, wherein A is the hydrocarbon residue of a diamine of the formula H₂N—(CH₂)ₙ—NH₂ wherein n is 2-6, or is p-phenylenediamine, lysine, or a diamine of the formula H₂N—(CH₂)₃—O—(CH₂—CH₂—O)ₘ—(CH₂—CHCH₃—O)_{I}—(CH₂)₃—NH₂, wherein m and I are independently 0 to 50 and m plus I is ≧1.

9. A composition according to claim 1 wherein for formula (I) or (II), A is a hydrocarbon residue of an optionally substituted and/or interrupted polyamine.

10. A composition according to claim 9, wherein A is the hydrocarbon residue of a polyalkyleneamine of the formula H₂N—(CH₂CHR—NH)ₙ—CH₂CHR—NH₂, wherein n is 1 to 5 and R is hydrogen or methyl, or aminoethylpiperazine, iminobispropylamine or N,N′-bis(3-aminopropyl)ethylenediamine, or is a polyethyleneimine of molecular weight 200 to 2,000 or polylysine.

11. A composition according to claim 1 wherein for formula (I) or (II), A is the optionally substituted and/or interrupted hydrocarbon residue of a polyethyleneimine of molecular weight 200 to 1,000, diethylenetriamine, triethylenetetramine, N,N′-bis(3-aminopropyl)ethylenediamine, lysine or polylysine.

12. A composition according to claim 1 wherein for formula (I) or (II), Q is of formula —C(═O)CH₃; —(CH₂)₁₋₃COOH; —C(═O)—CR═CH₂, wherein R is hydrogen or methyl; —CH₂CH═CH₂; —CH₂CH(OH)CH₂—O—CH₂ CH═CH₂; —CH₂CH═CH—R_{F} or —CH₂CH(OH)CH₂—O—CH₂—CH═CH—R_{F}, where R_{F} is as defined in claim 1; —C(═O)—(CH₂)₂—COOH; —C(═O)—CH═CH—COOH; —C(═O)—C(═CH₂)—CH₂—COOH; —C(═O)—CH₂—C(═CH₂)—COOH; —C(═O)—(C₆H₈)—COOH; —C(═O)—(C₇H₈)—COOH; —C(═O)—(C₈H₁₀)—COOH; —C(═O)—(CH₂)₈CH—50 CH₂; —CH₂—CHOH—CH₂—O—(CH₂ CHR—O)ₘ—R₂, where m is 1 to 50 and R₂ is hydrogen or C₁-C₁₂alkyl; —P(═O)(OH)₂; —SO₃H, or —CH₂CH₂N(CH₃)₂.

13. A composition according to claim 12, wherein Q is of the formula —C(═O)CH₃; —C(═O)—CH═CH₂; —CH₂—COOH; —C(═O)—(CH₂)₂—COOH or —C(═O)—(C₆H₈)—COOH.

14. A composition according to claim 1 wherein for formula (I) or (II), Q₁ is of formula —(C═O)—HN-Z-NHC(═O)—, wherein Z is the diradical hydrocarbon residue of p- or m-toluene diisocyanate, isophorone diisocyanate, 3,3,4(3,4,4)-trimethylhexane-1,6-diisocyanate or hexane-1,6-diisocyanate; —C(═O)—; —CH₂—CHOH—CH₂— or —CH₂—CHOH—CH₂—O—(CH₂ CH₂—O)ₘ—(CH₂ CHCH₃—O)_{I}—CH₂—CHOH—CH₂—, wherein m and I are independently 0 to 50 and m plus I is ≧1; —C(═O)—C₆H₄(—COOH)₂—C(═O)—; or —C(═O)—CH₂C(═CH₂)—C(═O)— or —C(═O)-D-C(═O)—, wherein D is the hydrocarbon residue of an aliphatic or aromatic dicarboxylic acid having from 2 to 10 carbon atoms.

15. A composition according to claim 14, wherein Q₁ is of the formula: —CH₂—CHOH—CH₂—; —C(═O)—C₆H₄(—COOH )₂—C(═O)—; —C(═O)—CH₂CH₂—C(═O)— or —C(═O)HN-Z-NHC(═O)— wherein Z is the diradical residue of p- or m-toluene diisocyanate, isophorone diisocyanate, 3,3,4(3,4,4)-trimethylhexane-1,6-diisocyanate or hexane-1,6-diisocyanate.

16. A composition according to claim 1 wherein component (i) comprises a compound of formula (III)
Q_{z}-A-(C(═O)—(CH₂)₈CH═CH—R_{F})₂ (III),
wherein
A is derived from diethylenetriamine, triethylenetetramine or N,N′-bis(3-aminopropyl)ethylene-diamine, Q is —C(═O)CH₃; —C(═O)—CH═CH₂; —CH₂—COOH; —C(═O)—(CH₂)₂—COOH or —C(═O)—(C₆ H₈)—COOH, z is 1 or 2, and each R_{F} is independently a monovalent perfluorinated linear alkyl radical having 6 to 14 fully fluorinated carbon atoms.

17. A composition according to claim 1 wherein component (i) comprises a compound of formula (IV)
(Q₁-A-NH—C(═O)—(CH₂)₈CH═CH—R_{F})₂-A-(NH—C(═O)—(CH₂)₈CH═CH—R_{F})₂ (IV),
wherein A is derived from diethylenetriamine and Q₁ is a difunctional radical of the formula —CH₂—CHOH—CH₂—; —C(═O)—CH₂CH₂—C(═O)—; —C(═O)—; —C(═O)—C₆H₄(—COOH)₂—C(═O), or —C(═O)—NH-Z-NH—C(═O)—, wherein Z is the diradical hydrocarbon residue of p- or m-toluene diisocyanate, isophorone diisocyanate, 3,3,4(3,4,4)-trimethylhexane-1,6-diisocyanate or hexane-1,6-diisocyanate, and each R_{F} is independently a monovalent perfluorinated linear alkyl radical having 6 to 14 fully fluorinated carbon atoms.

18. A composition according to claim 17, wherein component (i) comprises a compound of formula (V)
(R_{F}—CH═CH(CH₂)₈C(═O)—NH)₂-A-Q₁-A-(NHC(═O)(CH₂)₈CH═CH—R_{F})₂ (V).

19. A composition according to claim 1 wherein component (i) comprises a compound of formula (VI)
A-(Q₁-A-(NHC(═O)(CH₂)₈CH═CH—R_{F})₂)_{y}—(NHC(═O)(CH₂)₈CH═CH—R_{F})₂ (VI),
wherein
y is 2 to 50, A is derived from triethylenetetramine or N′N-bis(3-aminopropyl)ethylenediamine and Q₁ is of the formula ‘3CH₂—CHOH—CH₂—, —C(═O)—CH₂CH₂—C(═O)—; —C(═O)—, —C(═O)—C₆H₄(—COOH)₂—C(═O)—, or —C(═O)—HN-Z-NH—C(═O)—, wherein Z is the diradical hydrocarbon residue of p- or m-toluene diisocyanate, isophorone diisocyanate, 3,3,4(3,4,4)-trimethylhexane-1,6-diisocyanate or hexane-1,6-diisocyanate.

20. A composition according to claim 1 wherein said cationic group is selected from the group consisting of a primary (—NH2) amine salt of an HY acid, a secondary (—NHT5) amine salt of an HY acid, a tertiary (—NT5T6) amine salt of an HY acid and a quarternary ammonium group (—N+T3T4T5)Y—,
wherein HY is an inorganic or organic acid,
Y is phosphate, phosphonate, carbonate, bicarbonate, nitrate, chloride, bromide, bisulfite, sulfite, bisulfate, sulfate, borate, formate, acetate, benzoate, citrate, oxalate, tartrate, acrylate, polyacrylate, fumarate, maleate, itaconate, glycolate, gluconate, malate, mandelate, tiglate, ascorbate, polymethacrylate, a carboxylate of nitrilotriacetic acid, a carboxlylate of hydroxyethylethylenediaminetriacetic acid, a carboxylate of ethylenediaminetetraacetic acid, a carboxylate of diethylenetriaminepentaacetic acid, a carboxylate of diethylenediaminetetraacetic acid, a carboxylate of diethylenetriaminepentaacetic acid, alkylsulfonate, arylsulfonate, or alkyl-substituted arylsulfonate, and
T3, T4, T5 and T6 are defined above.

21. A method of hard surface cleaning, which comprises contacting said surface with an effective cleaning amount of a cleaning composition according to claim 1.

22. A method according to claim 21, wherein the surface is ceramic tile, stone, glass, cement, concrete, bricks, plaster, marble; masonry countertops of stone, marble or plastic; and wood, plastic, laminates or other types of floors made of organic or inorganic materials.

23. A method of treating a hard surface whereby resistance to soiling and ease of subsequent soil removal is improved, which comprises contacting said hard surface with an effective amount of a composition according to claim 1.

24. A method according to claim 23, wherein the surface is ceramic tile, stone, glass, cement, concrete, bricks, plaster, marble; masonry countertops of stone, marble or plastic; and wood, plastic, laminates or other types of floors made of organic or inorganic materials.
